(19) United States
(12) Patent Application Publication
(10) Pub. No.: US 2026/0183762 A1
(43) Pub. Date: Jul. 2, 2026

(54) CASSETTE-BASED REVERSIBLE FLOW CELL

(71) Applicant: 10x Genomics, Inc., Pleasanton, CA (US)

(72) Inventors: Brenden Janatpour Brown, Castro Valley, CA (US); Martin Sauzade, Pleasanton, CA (US); Yiran Zhang, Castro Valley, CA (US)

(21) Appl. No.: 19/424,725

(22) Filed: Dec. 18, 2025

Related U.S. Application Data
(60) Provisional application No. 63/740,049, filed on Dec. 30, 2024.

(51) Int. Cl. B01L 3/00

(52) U.S. Cl. CPC B01L 3/50273; B01L 2300/046; B01L 2300/069; B01L 2300/0816; B01L 2400/049

(57) ABSTRACT

The assembly comprises a substrate configured to receive a sample, a gasket and a cover. The gasket has an upper surface and a lower surface defining a first thickness therebetween, a void having a first cutout at a first end of the void and a second cutout at a second end of the void opposite the first end, a cover support extending into the void. The cover support has a second thickness that is less than the first thickness. The cover is configured to be positioned within the void and supported by the cover support such that, when the cover is positioned within the void, a gasket inlet is defined by the first cutout and the cover and a gasket outlet is defined by the second cutout and the cover to thereby define a closed flow cell between the substrate, gasket and cover.

### CROSS-REFERENCE TO RELATED APPLICATION

This application claims the benefit of priority to U.S. Provisional App. No. 63/740,049, filed on December 30, 2024. The entire contents of which are hereby incorporated by reference.

### FIELD

The present disclosure relates to assemblies and methods for delivering a liquid reagent to a sample. Particularly, the present disclosed subject matter is directed to reversible flow cells.

### BACKGROUND

Many biomedical applications rely on high-throughput assays of biological samples contacted with one or more reagents using flow devices (e.g., open well flow cells and closed flow cells). For example, in both research and clinical applications, high-throughput assays using target-specific reagents for analyzing molecules present in a biological sample can provide information for various applications. Reducing the volume of reagent(s) employed can significantly reduce cost, and cycle time (i.e., less volume of liquid is required to be delivered to, and removed, the tissue sample). Some exemplary fluidic systems are disclosed in U.S. Patent No. 8,629,264 and U.S. Patent No. 10,710,076, the entire contents of which are hereby incorporated by reference.

Closed flow cells that can be reversibly formed around a sample can have advantages over open well flow cells in that the volume of reagent required to contact the sample (e.g., fully submerge the sample) can be significantly decreased compared to the volume of reagent required to fully contact the same sample in an open well flow cell. Moreover, reversible closed flow cells can be formed around samples (e.g., archival samples or fresh frozen samples), which are typically stored on commercially-available microscope slides, enabling analysis of a broader range of samples. Some analysis instruments use a cassette that is assembled around a substrate (such as a commercially-available microscope slide) on which a sample is positioned to secure the substrate and form an open well around the sample. However, when contacting the sample with expensive reagents during sample preparation, library preparation, and/or analysis of target analytes within the sample, it is desirable to minimize the volume of reagent required to reduce the cost of goods sold (COGS) of each assay.

Accordingly, there exists a need for a method and system for reducing the volume of regents required to contact a sample during in situ analysis while allowing for high-resolution imaging of samples.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes an assembly comprising a substrate configured to receive a sample, a gasket, and a cover. The gasket having an upper surface and a lower surface defining a first thickness therebetween, a void having a first cutout at a first end of the void and a second cutout at a second end of the void opposite the first end, a plurality of cover supports extending into the void. The plurality of cover supports has a second thickness that is less than the first thickness. The cover is configured to be positioned within the void and supported by the plurality of cover supports such that, when the cover is positioned within the void, a gasket inlet is formed by the first cutout and the cover, and a gasket outlet is formed by the second cutout and the cover to thereby define a closed flow cell between the substrate, gasket and cover.

In some embodiments, the assembly further comprises a base and a top. The base has an upper surface and a lower surface defining a thickness therebetween, where the substrate is disposed on the upper surface of the base. The top has an upper surface and a lower surface defining a thickness therebetween. The top is configured to removably couple to the base. The top has at least one opening extending through the upper surface and lower surface with at least one downwardly extending wall disposed around a perimeter of the opening. The cover extends across the opening in the top.

In some embodiments, further comprising a fluidic inlet and a fluidic outlet at opposite sides of the opening.

In some embodiments, the fluidic inlet of the top and the fluidic outlet of the top are oriented vertically with respect to the upper surface of the top.

In some embodiments, the fluidic inlet of the top and the fluidic outlet of the top extend vertically above the upper surface of the top.

In some embodiments, the gasket inlet is vertically aligned with the fluidic inlet of the top, and the gasket outlet is vertically aligned with the fluidic outlet of the top.

In some embodiments, at least one of the fluidic inlet or the fluidic outlet has an orifice of greater diameter than an orifice of the gasket inlet or the gasket outlet.

In some embodiments, the top includes a plurality of snap joints at opposite sides thereof, the clamps configured to removably couple the top to the base with the slide, gasket and cover fixedly disposed therebetween.

In some embodiments, the closed flow cell directs fluids received from the fluidic inlet to the fluidic outlet of the top.

In some embodiments, the gasket forms a fluid-tight seal between the substrate and the top.

In some embodiments, the cover is transparent.

The disclosed subject matter also includes a method of assembling a reversible flow cell. A substrate configured to receive a sample is provided. A gasket is positioned on the substrate. The gasket has an upper surface and a lower surface defining a first thickness therebetween, a void, a plurality of cover supports extending into the void, a first cutout positioned at a first end of the void, and a second cutout positioned at a second end of the void opposite the first end. The plurality of cover supports has a second thickness that is less than the first thickness. A cover is positioned within the void such that the cover is supported by the plurality of cover support such that, when the cover is positioned within the void, a gasket inlet is formed by the first cutout and the cover, and a gasket outlet is formed by the second cutout and the cover to thereby define a closed flow cell between the substrate, gasket and cover.

The disclosed subject matter also includes an assembly comprising a base, at least one substrate, a gasket, and a cover. The base includes an upper surface and a lower surface defining a thickness therebetween, at least one vacuum port formed in the upper surface. The at least in substrate is disposed on the upper surface of the base. The substrate is configured to receive a sample. The gasket is disposed over the substrate. The gasket includes a plurality of apertures with at least one aperture disposed over the at least one vacuum port of the base. The gasket has a void with a first cutout at a first end of the void and a second cutout at a second end opposite the first end. The cover extends across the void and includes a fluidic inlet in fluidic communication with the first cutout and a fluidic outlet in fluidic communication with the second cutout to define a closed flow cell between the substrate, gasket and the cover. A vacuum applied through the at least one vacuum port secures the cover, gasket, and the at least one substrate.

In some embodiments, the at least one vacuum port is in fluidic communication with a plurality of grooves extending between a first side and a second side of the base.

In some embodiments, a first groove of the plurality of grooves is configured as a rectangular loop, the loop vertically aligned with and disposed below the substrate.

In some embodiments, a second groove and a third groove of the plurality of grooves are configured as rectangular loops, the second loop and the third loop vertically offset with and disposed below the substrate.

In some embodiments, a plurality of apertures is vertically aligned with the second groove and the third groove of the plurality of grooves.

In some embodiments, the first groove of the plurality of grooves is disposed at a lower height in the base than the second groove and the third groove of the plurality of grooves.

In some embodiments, the flow cell is configured to transport fluids from the fluidic inlet, across the substrate, to the fluidic outlet.

In some embodiments, the cover is transparent.

In some embodiments, the base includes at least one protruding gasket registration structure configured to engage at least a portion of a gasket.

In some embodiments, the base includes at least one protruding slide registration structure configured to engage at least one side of the substrate.

The disclosed subject matter also includes a method of assembling a reversible flow cell. A substrate configured to receive a sample is provided. The substrate is positioned on the base. The base includes an upper surface and a lower surface defining a thickness therebetween, and at least one vacuum port formed in the upper surface. A gasket is positioned on the substrate and the base. The gasket includes a plurality of apertures with at least one aperture disposed over the least one vacuum port of the base. The gasket has a void with a first cutout at a first end of the void and a second cutout at a second end opposite the first end. A cover is positioned over the gasket. The cover extends across the void and includes a fluidic inlet in fluidic communication with the first cutout and a fluidic outlet in fluidic communication with the second cutout to define a closed flow cell between the substrate, gasket and the cover.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present disclosure and may illustrate one or more embodiment(s) or example(s) of the present disclosure in whole or in part.

FIG. 1A is an exploded view of a first exemplary assembly, in accordance with an embodiment of the present disclosure.

FIG. 1B is a view of an assembled first exemplary assembly, in accordance with an embodiment of the present disclosure.

FIG. 2 and FIG. 3 are section partial side views of a first exemplary assembly, in accordance with an embodiment of the present disclosure.

FIG. 4A and FIG. 4B are exploded views of second exemplary assembly, in accordance with an embodiment of the present disclosure.

FIG. 4C is a view of a second exemplary assembly, in accordance with an embodiment of the present disclosure.

FIG. 4D is a view of an assembled exemplary assembly with hidden lines, in accordance with an embodiment of the present disclosure.

FIG. 4E is a top view of an assembled exemplary assembly with hidden lines, in accordance with an embodiment of the present disclosure.

FIG. 5 is a flowchart illustrating a method for assembling a reversible closed flow cell, in accordance with an embodiment of the present disclosure.

FIG. 6 is a flowchart illustrating a method for assembling a reversible closed flow cell, in accordance with an embodiment of the present disclosure.

### DETAILED DESCRIPTION

### Definitions

To facilitate the understanding of this disclosure, a number of terms are defined below. Terms defined herein have meanings as commonly understood by a person of ordinary skill in the areas relevant to the disclosure. Terms such as “a”, “an,” and “the” are not intended to refer to only a singular entity, but include the general class of which a specific example may be used for illustration. The terminology herein is used to describe specific embodiments of the disclosure, but their usage does not limit the disclosure, except as outlined in the claims.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ±10% of a recited value.

As used herein, any values provided in a range of values include both the upper and lower bounds, and any values contained within the upper and lower bounds.

The term “biological particle,” as used herein, generally refers to a discrete biological system derived from a biological sample. The biological particle may be a virus. The biological particle may be a cell or derivative of a cell. The biological particle may be an organelle from a cell. Examples of an organelle from a cell include, without limitation, a nucleus, endoplasmic reticulum, a mitochondrion, a ribosome, a Golgi apparatus, an endoplasmic reticulum, a chloroplast, an endocytic vesicle, an exocytic vesicle, a vacuole, and a lysosome. The biological particle may be a rare cell from a population of cells. The biological particle may be any type of cell, including without limitation prokaryotic cells, eukaryotic cells, bacterial, fungal, plant, mammalian, or other animal cell type, mycoplasmas, normal tissue cells, tumor cells, or any other cell type, whether derived from single cell or multicellular organisms. The biological particle may be a constituent of a cell. The biological particle may be or may include DNA, RNA, organelles, proteins, or any combination thereof. The biological particle may be or may include a matrix (e.g., a gel or polymer matrix) including a cell or one or more constituents from a cell (e.g., cell bead), such as DNA, RNA, organelles, proteins, or any combination thereof, from the cell. The biological particle may be obtained from a tissue of a subject. The biological particle may be a hardened cell. Such hardened cell may or may not include a cell wall or cell membrane. The biological particle may include one or more constituents of a cell but may not include other constituents of the cell. An example of such constituents is a nucleus or an organelle. A cell may be a live cell. The live cell may be capable of being cultured, for example, being cultured when enclosed in a gel or polymer matrix or cultured when including a gel or polymer matrix.

The term “fluidically connected”, as used herein, refers to a direct connection between at least two device elements, e.g., a channel, reservoir, etc., that allows for fluid to move between such device elements without passing through an intervening element.

The term “genome,” as used herein, generally refers to genomic information from a subject, which may be, for example, at least a portion or an entirety of a subject's hereditary information. A genome can be encoded either in DNA or in RNA. A genome can include coding regions that code for proteins as well as non-coding regions. A genome can include the sequence of all chromosomes together in an organism.

For example, the human genome has a total of 46 chromosomes. The sequence of all of these together may constitute a human genome.

The term “in fluid communication with”, as used herein, refers to a connection between at least two device elements, e.g., a channel, reservoir, etc., that allows for fluid to move between such device elements with or without passing through one or more intervening device elements.

The term “macromolecular constituent,” as used herein, generally refers to a macromolecule contained within or from a biological particle. The macromolecular constituent may include a nucleic acid. In some cases, the biological particle may be a macromolecule. The macromolecular constituent may include DNA or a DNA molecule. The macromolecular constituent may include RNA or an RNA molecule. The RNA may be coding or non-coding. The RNA may be messenger RNA (mRNA), ribosomal RNA (rRNA) or transfer RNA (tRNA), for example. The RNA may be a transcript. The RNA molecule may be (i) a clustered regularly interspaced short palindromic (CRISPR) RNA molecule (crRNA) or (ii) a single guide RNA (sgRNA) molecule. The RNA may be small RNA that are less than 200 nucleic acid bases in length, or large RNA that are greater than 200 nucleic acid bases in length. Small RNAs may include 5.8S ribosomal RNA (rRNA), 5S rRNA, transfer RNA (tRNA), microRNA (miRNA), small interfering RNA (siRNA), small nucleolar RNA (snoRNAs), Piwi-interacting RNA (piRNA), tRNA-derived small RNA (tsRNA) and small rDNA-derived RNA (srRNA). The RNA may be double-stranded RNA or single-stranded RNA. The RNA may be circular RNA. The macromolecular constituent may include a protein. The macromolecular constituent may include a peptide. The macromolecular constituent may include a polypeptide or a protein. The polypeptide or protein may be an extracellular or an intracellular polypeptide or protein. The macromolecular constituent may also include a metabolite. These and other suitable macromolecular constituents (also referred to as analytes) will be appreciated by those skilled in the art (see U.S. Pat. Nos. 10,011,872 and 10,323,278, and PCT Publication No. WO 2019/157529, each of which is incorporated herein by reference in its entirety).

The term “particulate component of a cell” refers to a discrete biological system derived from a cell or fragment thereof and having at least one dimension of 0.01 μm (e.g., at least 0.01 μm, at least 0.1 μm, at least 1 μm, at least 10 μm, or at least 100 μm). A particulate component of a cell may be, for example, an organelle, such as a nucleus, an exosome, a liposome, an endoplasmic reticulum (e.g., rough or smooth), a ribosome, a Golgi apparatus, a chloroplast, an endocytic vesicle, an exocytic vesicle, a vacuole, a lysosome, or a mitochondrion.

The terms “sample,” “tissue sample,” and “biological tissue sample” as used herein, refers to material from a subject, such as a biopsy, core biopsy, tissue section, needle aspirate, or fine needle aspirate or skin sample. The biological tissue sample may be derived from another sample. The biological sample may be a nucleic acid sample or protein sample. The sample may be a liquid sample, such as a blood sample, urine sample, or saliva sample. The sample may be a skin sample. The sample may be a cheek swap. The sample may be a plasma or serum sample. The sample may include a biological particle, e.g., a cell or virus, or a population thereof, or it may alternatively be free of biological particles. A cell-free sample may include polynucleotides. Polynucleotides may be isolated from a bodily sample that may be selected from the group consisting of blood, plasma, serum, urine, saliva, mucosal excretions, sputum, stool, and tears.

The term “sequencing,” as used herein, generally refers to methods and technologies for determining the sequence of nucleotide bases in one or more polynucleotides. The polynucleotides can be, for example, nucleic acid molecules such as deoxyribonucleic acid (DNA) or ribonucleic acid (RNA), including variants or derivatives thereof (e.g., single stranded DNA). Sequencing can be performed by various systems currently available, such as, without limitation, a sequencing system by ILLUMINA®, Pacific Biosciences (PACBIO®), Oxford NANOPORE®, or Life Technologies (ION TORRENT®). Alternatively, or in addition, sequencing may be performed using nucleic acid amplification, polymerase chain reaction (PCR) (e.g., digital PCR, quantitative PCR, or real time PCR), or isothermal amplification. Such systems may provide a plurality of raw genetic data corresponding to the genetic information of a subject (e.g., human), as generated by the systems from a sample provided by the subject. In some examples, such systems provide sequencing reads (also “reads” herein). A read may include a string of nucleic acid bases corresponding to a sequence of a nucleic acid molecule that has been sequenced. In some situations, systems and methods provided herein may be used with proteomic information.

The term “subject,” as used herein, generally refers to an animal, such as a mammal (e.g., human) or avian (e.g., bird), or other organism, such as a plant. The subject can be a vertebrate, a mammal, a mouse, a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that is in need of therapy or suspected of needing therapy. A subject can be a patient.

The term “inlet” and “port” as used herein, generally refers to an aperture, orifice or channel extending through at least a portion of a device layer.

Reference will now be made in detail to exemplary embodiments of the disclosed subject matter, an example of which is illustrated in the accompanying drawings. The method and corresponding steps of the disclosed subject matter will be described in conjunction with the detailed description of the system.

The methods, assemblies, and systems presented herein relate to an adapter configured to reduce a volume of reagent required to fully contact (e.g., submerge) a biological sample (e.g. cell or tissue sample) in an open well flow cell, thereby forming a reversible flow cell upon positioning of the adapter in the well. Reducing the volume of the open well reduces the amount of reagent(s) needed for sample preparation (e.g., tissue sample preparation for analysis of biological molecules, such as RNAs and/or proteins), which provides significant cost savings when using expensive sample preparation reagents (e.g., one or more antibodies) and can also reduce cycle time, as less time is need to dispense and remove the reagent(s) employed. For purpose of illustration and without limitation, in an exemplary embodiment, the height of liquid required in the flow cell can be reduced from approximately 1.0mm (1000µm) to approximately 0.2mm (200µm). This approximately 0.8mm spatial reduction can reduce the amount of reagent volume used within the flow cell from about 500 µl to approximately 100 µl.

### Assembly 100

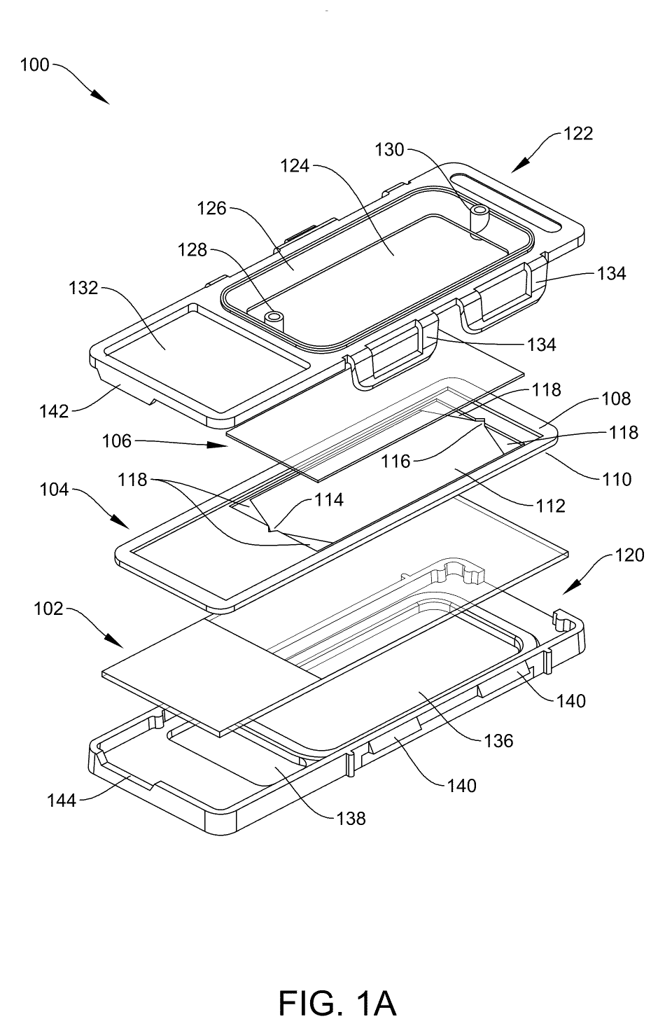

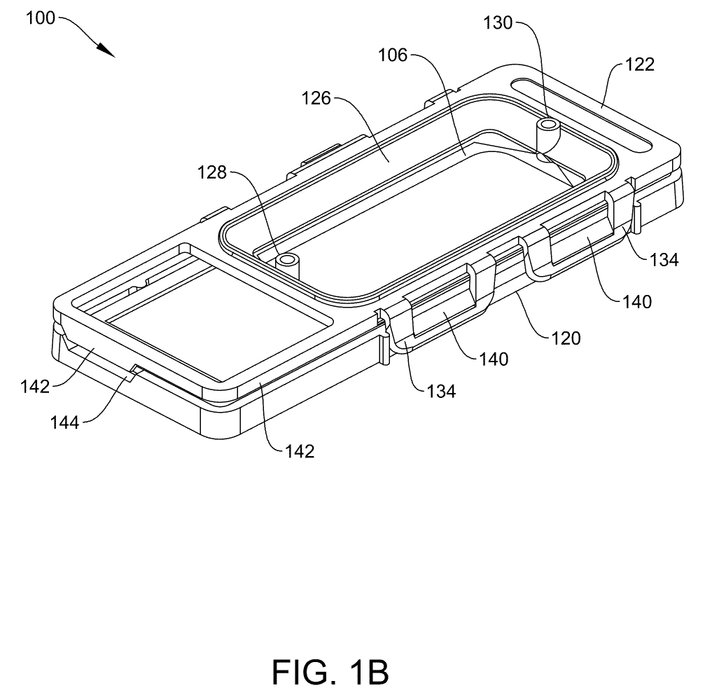

FIG. 1A is an exploded view of an exemplary assembly for delivering one or more reagents to one or more samples disposed on a substrate. FIG. 1B is an orthographic projection of an assembled exemplary assembly. As shown in FIG. 1A and FIG. 1B, an assembly 100 includes a substrate 102 configured to receive a sample, a gasket 104, and a cover 106. In some embodiments, at least a portion of the cover 106 is transparent. In some embodiments, at least a portion of the cover 106 is optically clear. In some embodiments, the substrate 102 is a microscope (e.g., glass) slide. One or more samples can be disposed on the substrate 102 and a portion of the substrate 102 free from biological sample can include labeling (e.g., barcode) or other indicia. In some embodiments, the cover 106 is a cover slip. In some embodiments, the sample is a biological sample (e.g., a tissue section). In some embodiments, the sample is a hydrogel having a plurality of molecular targets (e.g., amplicons) disposed therein. In some embodiments, the sample includes one or more cells (e.g., dissociated single cells on a substrate for in situ analysis of the single cells).

The gasket 104 has an upper surface 108 and a lower surface 110 defining a thickness therebetween. The gasket 104 includes a void 112 and at least one cover support 118 extending into the void. The cover support 118 can be configured as multiple discrete members, or a single integral component that is coupled to the gasket. The void 112 has a first cutout 114 at a first end of the void 112 and a second cutout 116 at a second end of the void 112 opposite the first end. In the exemplary embodiment of FIG. 1A, the cutouts 114, 116 are located at a midpoint (in the X-direction) of the void 112. The surface area defined by the cover supports 118, which receives the cover 106 thereon, can vary depending upon the size of the substrate to be employed with the current disclosure.

In some embodiments, the first cutout 114 and second cutout 116 are circular (e.g., a semicircle cutout). In some embodiments, the first cutout 114 and second cutout 116 are rectangular. The plurality of cover supports 118 have a thickness that is less than the thickness of the gasket 104. The cover 106 is configured to be positioned within the void 112 and supported by the cover supports 118 such that, when the cover 106 is positioned within the void 112, a gasket inlet is defined by the first cutout 114 and the cover 106, and a gasket outlet is defined by the second cutout 116 and the cover 106 to thereby define a closed flow cell between the substrate 102, gasket 104, and cover 106. In some embodiments, the void 112 may be alternatively described as a cutout or aperture in the gasket (which may include first cutout 114 and second cutout 116).

In this way, the sample is disposed within the closed flow cell (e.g., a central portion of the closed flow cell). In some embodiments, the gasket 104 forms a (first) fluid-tight seal between the substrate 102 and the cover 106, thereby defining a closed flow cell volume therebetween when the gasket 104 contacts the substrate 102 and cover 106. (It should be noted that a second fluid tight seal is formed between the cover 106 and the top 122 so that an open well is formed which can receive an immersion objective imaging device).

The void 112 includes one or more recessed portions having a depth and an opening extending through the thickness of the gasket 104. In some embodiments, the depth of the recessed portion(s) is less than a thickness of the gasket (e.g., a thickness of the gasket 104 measured outside of the void 112). The recessed portion is sized and shaped to receive a cover support 118. In some embodiments, the cover support 118 extends into (e.g., radially towards the center of) the void 112. In some embodiments, the cover support 118 extends around the inner perimeter of the void 112. In some embodiments, the cover support 118 includes two or more cover supports 118 that are spaced from one another (e.g., are not contiguous with one another). In some embodiments, the gasket 104 can circumscribe the void 112, and extend a greater distance into the void 112 than the cover support 118. In some embodiments, the cover support 118 has a planar body (e.g., to allow for a substantially planar cover slip to be positioned thereon). In some embodiments, the cover support includes an opening (e.g., rectangular opening) extending through the thickness of the cover support 118 such that the opening overlays the opening of the void 112. In some embodiments, the opening of the cover support 118 includes a pair of cutouts (e.g., semicircle cutouts) such that the edge(s) of the cutouts align with the edge(s) of the first cutout 114 and second cutout 116 of the void 112. In some embodiments, the area of the cover support opening is larger than the area of the opening of the void 112 such that the lower surface of the cover 106 is supported by a lower surface of the recessed portion and the edges of the cover 106 are supported by the cover support 118. In some embodiments, the area of the opening of the void 112 is smaller than the upper surface area of the cover 106. In some embodiments, the cover support opening encloses the outer perimeter of the cover 106, such that the cover support opening fits around the cover 106.

In some embodiments, the cover support 118 is integral with the gasket 104. In some embodiments, the cover support 118 is separate from the gasket 104 (e.g., is an insert that is separate from the gasket and may be made of the same or different material as the gasket). In the exemplary embodiment shown in FIG. 1A, the gasket 104 extends inwardly (in the X and Y direction) beyond the edges of the cover supports 118 and is formed with a triangular or tapered shape (such that the gasket is symmetrical about a longitudinal axis in the Y-direction).

In some embodiments, the gasket 104 and cover support 118 are formed of elastomer. In some embodiments, the gasket 104 is formed of an elastomer (e.g., silicone) and the cover support 118 is formed of a plastic (e.g., a thermoplastic). For example, and without limitation, elastomer can be overmolded on plastic to form the gasket 104 and cover support 118. In some embodiments, the thickness of the cover support 118 is approximately the height of the cover 106. In some embodiments, the cover support 118 includes multiple cover supports. In some embodiments, the height of the gasket 104 determines the height of the closed flow cell (i.e., the distance between the lower surface of the cover 106 and the upper surface of the substrate 102). In some embodiments, the shape of the closed flow cell is defined by the opening of the void, the upper surface of the substrate 102, and the lower surface of the cover 106. In some embodiments, the height of the closed flow cell is about 50 µm to about 200 µm. In some embodiments, the height of the closed flow cell is about 100 µm to about 150 µm.

In some embodiments, the assembly 100 includes a base 120 and a top 122. The top 122 is configured to removably couple to the base 120 (e.g., via a coupling mechanism), thereby securing the substrate 102, gasket 104, cover support 118, and cover support 106 therebetween. In some embodiments, the coupling mechanism includes one or more cantilevered snap joints. In some embodiments, the base 120 has a rectangular body. The base 120 has an upper surface and a lower surface defining a thickness therebetween, where the substrate 102 is disposed on the upper surface of the base 120. In some embodiments, the base 120 includes a recess (formed on the upper surface) defining an interior portion of the upper surface of the base 120. In some embodiments, the height of the recess is approximately the height of the substrate 102. In some embodiments, the base 120 includes a first base opening 136 (e.g., a rectangular opening), extending from the upper surface to the lower surface of the base, such that a portion of the substrate 102 (e.g., the portion where the sample is disposed) extends over the first base opening. In some embodiments, the base 120 includes a second base opening 138 (e.g., rectangular opening), extending from the upper surface to the lower surface of the base, such that a portion of the substrate 102 (e.g., the portion of the substrate free from biological sample which includes labeling) extends over the second base opening. In some embodiments, the area of the first base opening 136 is larger than the second base opening 138. The base 120 can be formed of one or more materials, including but not limited to a metal or metal alloy (e.g., aluminum, brass, copper, stainless steel, etc.) or a polymer (e.g., acrylic, polycarbonate, polypropylene, polyvinyl chloride, polyethylene, polyethylene terephthalate, poly(methyl methacrylate), etc.).

In some embodiments, the top 122 has a rectangular body. The top 122 has an upper surface and a lower surface defining a thickness therebetween. In some embodiments, the top 122 includes a first top opening 124 (e.g., rectangular opening) extending from the upper surface to the lower surface of the top. The first top opening 124 has at least one downwardly extending wall 126 disposed around a perimeter of the top opening 124. In some embodiments, the height of the wall 126 is about 1 mm to about 5 mm. In some embodiments, the height of the wall 126 is about 1 mm to about 2 mm. In some embodiments, the top 122 includes a second top opening 132 (e.g., rectangular opening). The top 122 can be formed of one more materials, including but not limited to a metal or metal alloy (e.g., aluminum, brass, copper, stainless steel, etc.) or a polymer (e.g., acrylic, polycarbonate, polypropylene, polyvinyl chloride, polyethylene, polyethylene terephthalate, poly(methyl methacrylate), etc.). For example, and without limitation, the top 122 can be formed of an overmolded elastomer on plastic.

In some embodiments, the top 122 is removably coupled to the base 120 using fasteners (e.g., screw, nut, washer, bolt). In some embodiments, the top 122 is removably coupled to the base 120 using mating joints. For example, and without limitation, the mating joint can include interlocking features that engage the base 120 and the top 122. The base 120 and top 122 can have complementary profiles (e.g., tongue-and-groove, pin-and-slot) that align when the top 122 is positioned over the base 120. In some embodiments, the top 122 is removably coupled to the base 120 using magnets. For example, and without limitation, magnets can be embedded in the lower surface of the top 122 and upper surface of the base 120. In some embodiments, the top 122 is removably coupled to the base 120 using a snap-fit mechanism (e.g. one or more cantilevered snap joints).

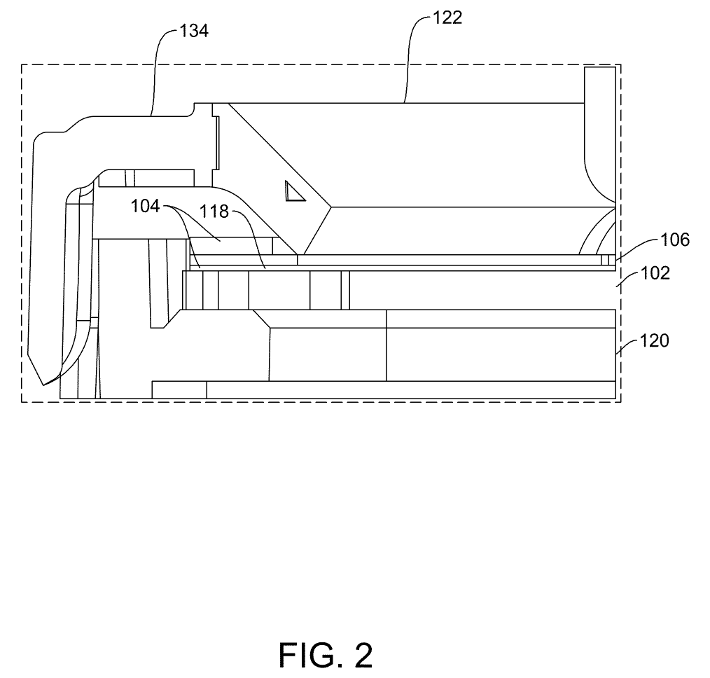

FIG. 2 is a section partial side view of the assembly 100 showing a snap joint 134 of the top engaged with a lug (not shown in FIG. 2) of the base 120. In some embodiments, the top 122 includes one or more snap joints 134 (e.g., cantilevered snap fit joints) configured to couple to corresponding lugs 140 (e.g., cantilevered lugs) of the base 120. In some embodiments, the top 122 includes four snap joints, while the base 120 includes four lugs. In some embodiments, the top 122 includes two snap joints, while the base 120 includes two lugs. In some embodiments, the snap joint(s) 134 of the top 122 are disposed along a side (e.g., longitudinal side) of the top 122, while the lug(s) are disposed along a side (e.g., longitudinal side) of the base 120. In some embodiments, the snap joints 134 of the top 122 are disposed on opposing sides (e.g., opposing longitudinal sides) of the top 122, while the lugs 140 are disposed on opposing sides (e.g., opposing longitudinal sides) of the base 120. In some embodiments, the top 122 includes the lug(s) 140, while the base 120 includes the snap joint(s) 134. The snap joint(s) 134 and lug(s) 140 are configured to removably couple the top 122 to the base 120 with the substrate 102, gasket 104 and cover 106 disposed and secured therebetween.

In some embodiments, the lower surface of the top 122 contacts the upper surface of the base 120 when the top 122 is removably coupled to the base 120. In some embodiments, there is a gap between the lower surface of the top 122 and the upper surface of the base 120 when the top 122 is removably coupled to the base 120. When the base 120 and top 122 are coupled, the first top opening 124 is positioned over (e.g., vertically aligned with) the opening of the void 112 and the first base opening 136. In some embodiments, where the top 122 includes the second top opening 132, the second top opening 132 is positioned over (e.g., vertically aligned with) a portion of the cover support 118.

The cover 106 extends across the first top opening 124 such that the downwardly extending wall 126 of the top contacts the cover 106, thereby defining an open well (e.g., a rectangular well, circular well) capable of containing a predetermined amount of fluid (e.g., imaging buffer, immersion buffer). In some embodiments, the downwardly extending wall 126 forms a fluid-tight seal against the cover 106. In some embodiments, the wall 126 has an inner wall angle that matches an angle of an imaging device configured to image the sample on the substrate 102 from above the closed flow cell. In some aspects, an inner wall angle of the wall 126 allows for increased travel distance of the objective when positioned to extend within the well.

In some embodiments, the imaging device is an objective lens part of an optical system in an optofluidic instrument. In some embodiments, a liquid dispensing mechanism is used to dispense a fluid (e.g., imaging buffer, immersion buffer) in the open well. In some embodiments, the liquid dispensing mechanism is a pipette (e.g., manual pipette, automatic (electronic) pipette) In some embodiments, the liquid dispensing mechanism includes a fluid pump (e.g., syringe pump, vacuum pump). In some embodiments, the liquid dispensing mechanism includes a fluid pump, a nozzle, syringe, needle, and/or tubing. In some embodiments, the objective lens is immersed in a buffer reagent contained in the well.

In some embodiments, the assembly 100 includes an alignment feature. For example, and without limitation, the top 122 can include a projection 142 extending from the lower surface of the top and the base 120 can include a complementary notch. In some embodiments, the top includes the complementary notch, while the base 120 includes the projection 142. In some aspects, the alignment feature prevents a user misaligning the base 120 and top 122 during assembly, ensuring that the openings of the top and base are correctly positioned relative to each other. For example, if the projection 142 is not aligned with the notch 144, this can prevent the snap joint(s) 134 from engaging with the lug(s) 140.

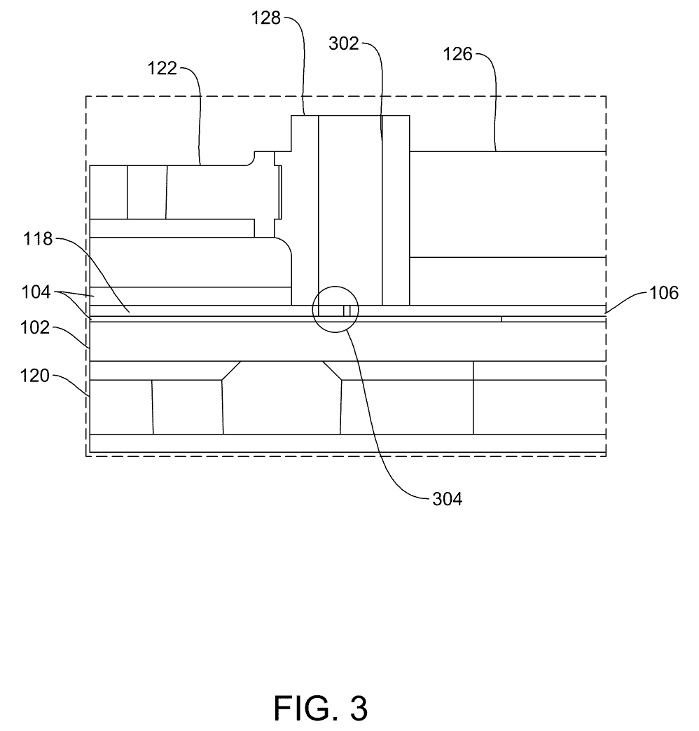

In some embodiments, the top 122 includes a fluidic inlet 128 and a fluidic outlet 130 at opposite sides of the first top opening 124. FIG. 3 is a section partial side view of the assembly 100 showing the fluidic inlet 128 of the top 122. In some embodiments, the fluidic inlet 128 of the top 122 and the fluidic outlet 130 of the top 122 are oriented vertically with respect to the upper surface of the top. In some embodiments, the fluidic inlet 128 of the top 122 and the fluidic outlet 130 of the top 122 extend vertically above the upper surface of the top. In some embodiments, the fluidic inlet 128 and fluidic outlet 130 each include a cylindrical body having a first end and a second end defining a thickness therebetween, and an orifice (e.g., orifice 302 of fluidic inlet 128) extending through the thickness of the cylindrical body. In some embodiments, the orifice has a uniform radius through the thickness. In some embodiments, orifice of the fluidic inlet 128 tapers from the first end to the second end of the cylindrical body. In some embodiments, at least one of the fluidic inlet 128 or the fluidic outlet 130 has an orifice of greater diameter than an orifice of the gasket inlet or the gasket outlet. In some embodiments, the gasket inlet 304 is vertically aligned with the fluidic inlet 128 of the top 122, and the gasket outlet is vertically aligned with the fluidic outlet 130 of the top 122.

The fluidic inlet 128 can be in fluid communication with the surrounding environment (e.g., ambient air). In some embodiments, a liquid dispensing mechanism is configured to dispense fluids (e.g., one or more liquid reagents) into the fluidic inlet 128. In some embodiments, the fluidic inlet 128 provides an interface for connecting with an outlet of the liquid dispensing mechanism. In some embodiments, the liquid dispensing mechanism extends within the orifice of the fluidic inlet 128.

In some embodiments, the closed flow cell directs fluids (e.g., one or more liquid reagents) received from the fluidic inlet 128 to the fluidic outlet 130 of the top 122. In some embodiments, the assembly 100 includes a liquid displacement mechanism configured to flow fluids from the fluidic inlet 128 to the fluidic outlet 130. In some embodiments, the liquid displacement mechanism is disposed upstream from and in fluidic communication with the fluidic inlet 128. In some embodiments, the liquid displacement mechanism is disposed downstream from and in fluidic communication with the fluidic outlet 130. In some embodiments, the fluidic outlet 130 provides an interface for connecting with an inlet of the liquid displacement mechanism. In some embodiments, the liquid displacement mechanism is a pipette (e.g., manual pipette, automatic (electronic) pipette) In some embodiments, the liquid displacement mechanism includes a fluid pump (e.g., syringe pump, vacuum pump). In some embodiments, the liquid displacement mechanism includes a fluid pump, a nozzle, syringe, needle, and/or tubing. In some embodiments, the liquid displacement mechanism generates a negative pressure (e.g., a pressure lower than the external pressure to the assembly 100), thereby drawing the liquid from the fluidic inlet 128 into the closed flow cell and out through the fluidic outlet. The negative pressure generated by the liquid displacement mechanism can be adjusted to control the flow rate of the liquid reagent.

### Assembly 400

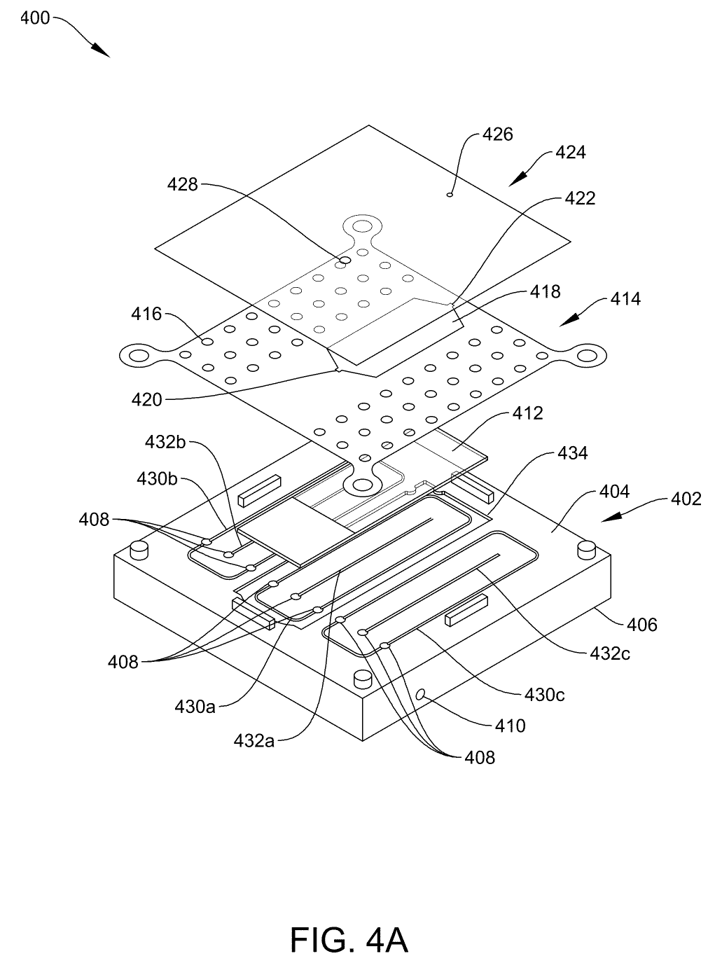

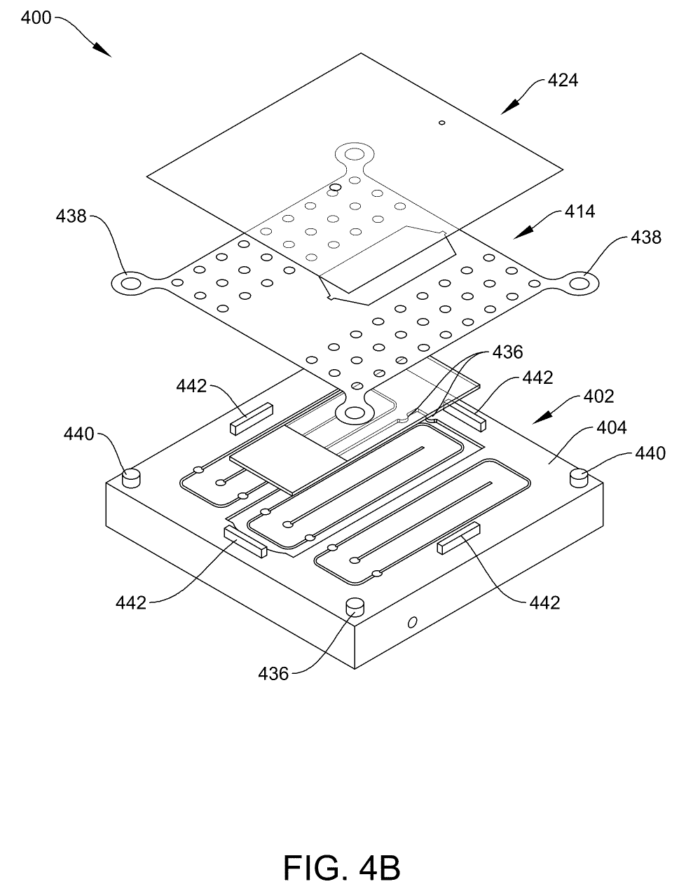

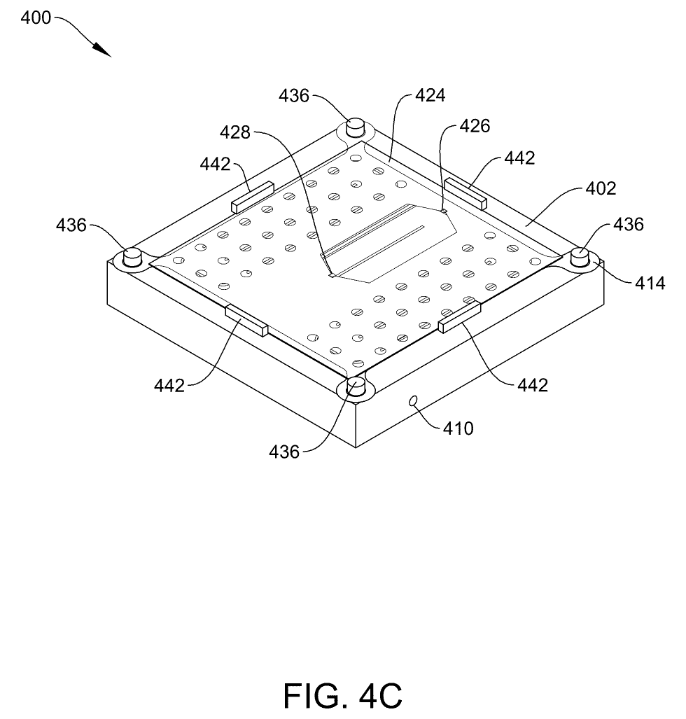

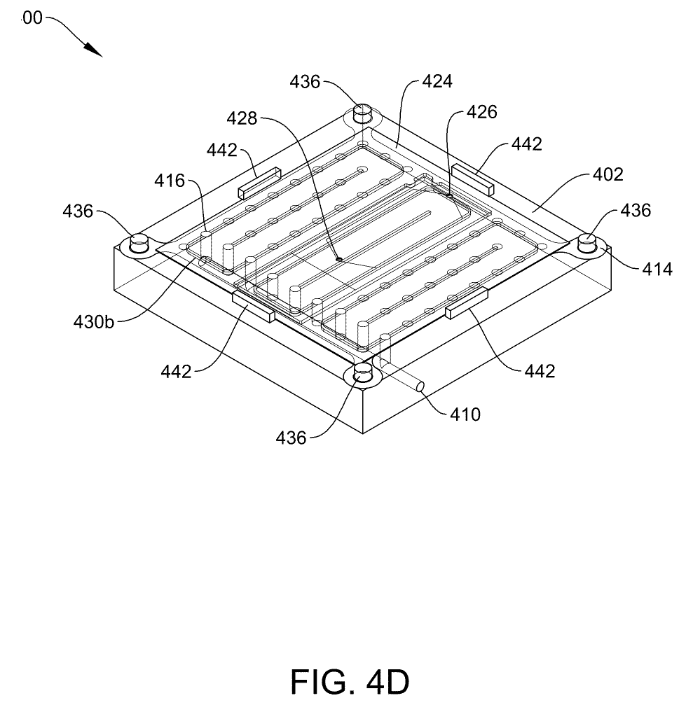

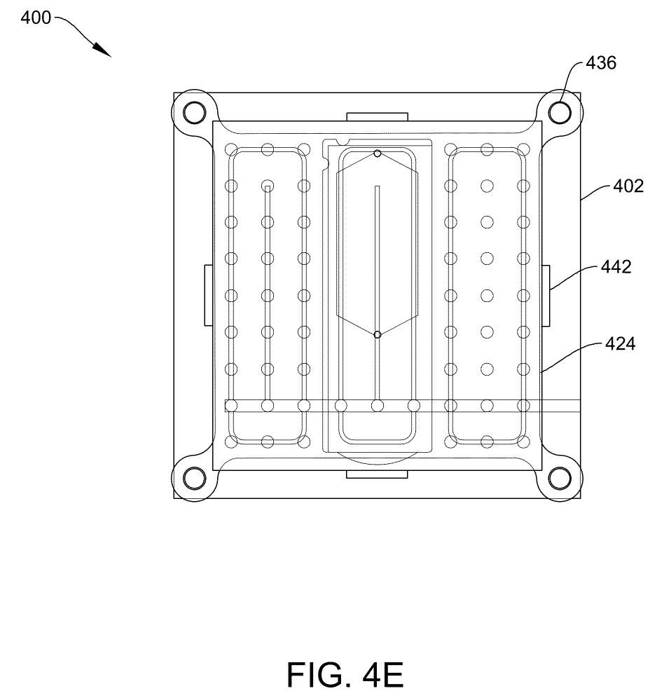

FIG. 4A and 4B are exploded views of an exemplary assembly for delivering one or more reagents to one or more samples disposed on a substrate 412. FIG. 4C is a view of an assembled exemplary assembly. FIG. 4D and FIG. 4E is a view and a top view, respectively, of an assembled exemplary assembly, with hidden lines showing features within the assembly. As shown in FIG. 4A - FIG. 4E, an assembly 400 includes a base 402, a gasket 414, and a cover 424. The base 402 includes an upper surface 404 and a lower surface 406 defining a thickness therebetween. The base 402 includes at least one vacuum port 408 formed in the upper surface 404. The base 402 includes at least one substrate 412 (e.g., optically transparent planar body, microscope slide, glass slide) disposed on the upper surface 404 of the base 402. The substrate 412 configured to receive a sample (e.g., a biological tissue sample, a hydrogel having multiple molecular targets). The gasket 414 is disposed over the substrate 412. The gasket 414 includes multiple apertures 416 with at least one aperture 416 disposed over the at least one vacuum port 408 of the base 402. The apertures 416 extend at least partially (from the upper surface towards the lower surface) through the thickness of the base 402. The gasket 414 has a void 418 with a first cutout 420 (e.g., a circular cutout, a rectangular cutout) and a second cutout 422 (e.g., a circular cutout, a rectangular cutout) at a second end opposite the first end. In some embodiments, the void 418 is an opening extending through the thickness of the gasket 414. In some embodiments, the area of the void 418 is smaller than the upper surface area of the substrate 412. The cover 424 has an upper surface and a lower surface defining a thickness therebetween. The cover 424 extends across the void 418 and includes a fluidic inlet 426 (e.g., a circular inlet) and fluidic outlet 428 (e.g., a circular outlet). The fluidic inlet 426 of the cover 424 is in fluidic communication with the first cutout 420, while the fluidic outlet 428 is in fluidic communication with the second cutout 422. A closed flow cell is defined between the substrate 412, gasket 414, and the cover 424. In this way, the sample is disposed within the closed flow cell (e.g., a central portion of the closed flow cell).

A vacuum applied through the vacuum port(s) 408 secures the cover 424, the gasket 414, and the least one substrate 412 together. In some embodiments, a pump port 410 is in fluidic communication with the vacuum port(s). In some embodiments, a vacuum pump configured to generate a negative pressure (e.g., a pressure lower than the external pressure to the assembly 400) is fluidically coupled to the pump port 410. In some embodiments, the pump port 410 is disposed on a side wall of the base 402. In some embodiments, one or more vacuum ports 408 are in fluidic communication with grooves formed in the upper surface 404 of the base 402 (between a first side and a second side of the base).

In some embodiments, the gasket 414 forms a fluid-tight seal between the substrate 412 and the cover 424, thereby defining the closed flow cell volume therebetween when the gasket 414 contacts the substrate 412 and cover 424. The gasket 414 can be formed of an elastomer. In some embodiments, the height of the gasket 104 determines the height of the closed flow cell (i.e., the distance between the lower surface of the cover 424 and the upper surface of the substrate 412). In some embodiments, the shape of the closed flow cell is defined by the opening of the void 418, the upper surface of the substrate 412, and the lower surface of the cover 424. In some embodiments, the height of the closed flow cell is about 25 µm to about 200 µm. In some embodiments, the height of the closed flow cell is about 50 µm to about 200 µm. In some embodiments, the height of the closed flow cell is about 50 µm to about 100 µm. In some embodiments, the height of the closed flow cell is about 50 µm to about 75 µm. In some embodiments, the height of the closed flow cell is about 100 µm to about 150 µm. In some embodiments, the volume of the closed flow cell is about 50 µl to about 250 µl. In some embodiments, the volume of the closed flow cell is about 50 µl to about 200 µl. In some embodiments, the volume of the closed flow cell is about 50 µl to about 150 µl. In some embodiments, the volume of the closed flow cell is about 50 µl to about 100 µl. In some embodiments, the volume of the closed flow cell is about 50 µl to about 75 µl.

In some embodiments, the apertures 416 are spaced laterally from the void 418 (e.g., laterally from the longitudinal sides of the void 418). In some embodiments, the apertures 416 (e.g., circular apertures, rectangular apertures) of the gasket 414 are arranged in a grid-like pattern (e.g. equidistant) and spaced from the void 418. In some embodiments, the apertures 416 of the gasket 414 are arranged in a radial pattern around the void 418. In some embodiments, when the gasket 414 is disposed and aligned over the base 402,

In some embodiments, the cover 424 is removably coupled to the base 402 using fasteners (e.g., screw, nut, washer, bolt). In some embodiments, the cover 424 is removably coupled to the base 402 using mating joints. For example, and without limitation, the mating joint can include interlocking features that engage the base 402 and the cover 424. The base 402 and cover 424 can have complementary profiles (e.g., tongue-and-groove, pin-and-slot) that align when the cover 424 is positioned over the base 402. In some embodiments, the cover 424 is removably coupled to the base 402 using magnets. In some embodiments, the cover 424 is removably coupled to the base 402 using a snap-fit mechanism. In some embodiments, the cover 424 is removably coupled to the base 402 using a clamping mechanism.

In some embodiments, the base 120 has a rectangular body. The base 402 can be formed of one or more materials, including but not limited to a metal or metal alloy (e.g., aluminum, brass, copper, stainless steel, etc.) or a polymer (e.g., acrylic, polycarbonate, polypropylene, polyvinyl chloride, etc.). In some embodiments, the base 402 includes multiple grooves formed on the upper surface 404, each groove having a depth, a width, and a cross-sectional shape (e.g., V-shaped, U-shaped, semi-circular, rectangular). In some embodiments, a first groove 430a is configured as a rectangular loop that is vertically aligned with and disposed below the substrate 412. In some embodiments, the first groove 430a surrounds a groove 432a that extends in a straight line across the surface. In some embodiments, at least one vacuum port 408 is in fluidic communication with the first groove 430a. In some embodiments, at least one vacuum port 408 is in fluidic communication with the groove 432a.

In some embodiments, the base 402 include a recess 434 (e.g., rectangular recess) formed on the upper surface defining an interior portion of the upper surface 404 configured to receive the substrate 412. In some embodiments, the base includes at least one protruding slide registration structure 436 configured to engage at least one side of the substrate 412. In some embodiments, the protruding slide registration structure 436 is a protrusion (e.g., circular protrusion, rectangular protrusion) extending into the recess 434. In some embodiments, the recess 434 defines a first slide registration structure 436 configured to contact a first side of the substrate 412. In some embodiments, the recess 434 defines a second side registration structure 436 configured to contact a second side of the substrate 412. In some embodiments, the first side is perpendicular to the second side. In some embodiments, the first side is parallel to the second side. In some embodiments, the first groove 430a is formed within the interior portion of the upper surface 404. In some embodiments, the groove 432a is formed within the interior portion of the upper surface 404.

In some embodiments, the base 402 includes a second groove 430b and a third groove 430c are configured as rectangular loops. In some embodiments, the first groove 430a is disposed at a lower height in the base 402 than a second groove 430b and a third groove 430c. In some embodiments, the second groove 430b and the third groove 430c are vertically offset with the first groove 430a. In some embodiments, the second grove 430b and the third groove 430c are vertically offset and disposed below the substrate 412. In some embodiments, the second groove 430b surrounds a groove 432b that extends in a straight line across the upper surface 404 of the base 402. In some embodiments, the groove 432b extends along a longitudinal axis of the second groove 430b. In some embodiments, the third groove 430c surrounds a groove 432c that extends in a straight line across the upper surface 404. In some embodiments, the groove 432c extends along a longitudinal axis of the third groove 430c. In some embodiments, one or more apertures 408 of the gasket 414 are vertically aligned with the second groove 430b and the third groove 430c.

In some embodiments, the cover 424 has a flat planar body. The cover 424 can be formed of one or more materials, including but not limited to a metal or metal alloy (e.g., aluminum, brass, copper, stainless steel, etc.) or a polymer (e.g., acrylic, polycarbonate, polypropylene, polyvinyl chloride, etc.). In some embodiments, at least portion of the cover 424 is transparent. In some embodiments, at least portion of the cover 424 is optically clear. In some embodiments, the fluidic inlet 426 is an opening (e.g., circular opening, rectangular opening) extending through the thickness of the cover 424. In some embodiments, the fluidic inlet 426 includes an interface for connecting with an outlet of a liquid dispensing mechanism. In some embodiments, the liquid dispensing mechanism extends within the opening of the fluidic inlet 426. The fluidic inlet 426 can be in fluid communication with the surrounding environment (e.g., ambient air). In some embodiments, a liquid dispensing mechanism is configured to dispense fluids (e.g., one or more liquid reagents) into the fluidic inlet 128. In some embodiments, a liquid dispensing mechanism is used to dispense a fluid (e.g., imaging buffer, immersion buffer) in the open well. In some embodiments, the liquid dispensing mechanism is a pipette (e.g., manual pipette, automatic (electronic) pipette) In some embodiments, the liquid dispensing mechanism includes a fluid pump (e.g., syringe pump, vacuum pump). In some embodiments, the liquid dispensing mechanism includes a fluid pump, a nozzle, syringe, needle, and/or tubing. In some embodiments, the fluidic outlet 428 is an opening (circular opening, rectangular opening) extending through the thickness of the cover 424.

In some embodiments, the closed flow cell transports fluids (e.g., one or more liquid reagents) received from the fluidic inlet 426, across the substrate 402, to the fluidic outlet 428. In some embodiments, the assembly 400 includes a liquid displacement mechanism configured to flow fluids from the fluidic inlet 426 to the fluidic outlet 428. In some embodiments, the liquid displacement mechanism is disposed upstream from and in fluidic communication with the fluidic inlet 426. In some embodiments, the liquid displacement mechanism is disposed downstream from and in fluidic communication with the fluidic outlet 428. In some embodiments, the liquid displacement mechanism is a pipette (e.g., manual pipette, automatic (electronic) pipette) In some embodiments, the liquid displacement mechanism includes a fluid pump (e.g., syringe pump, vacuum pump). In some embodiments, the liquid displacement mechanism includes a fluid pump, a nozzle, syringe, needle, and/or tubing. In some embodiments, the liquid displacement mechanism generates a negative pressure (e.g., a pressure lower than the external pressure to the assembly 400), thereby drawing the liquid from the fluidic inlet 426 into the closed flow cell and out through the fluidic outlet.

In some embodiments, the base 402 includes at least one protruding gasket registration structure 440 configured to engage at least a portion of the gasket 414. In some embodiments, the at least one protruding gasket registration structure 440 is a protrusion (e.g., a cylindrical protrusion, rectangular protrusion) extending from the upper surface 404 of the base 402. In some embodiments, the base 402 has at least one protruding gasket registration structure 440 on the upper surface 404 positioned proximate a side of the base 402. In some embodiments, the gasket 414 has at least one opening 438 (e.g., circular opening) extending through the thickness of the gasket that is shaped and sized to receive a protruding gasket registration structure 440. For example, and without limitation, the base 402 can include four protruding gasket registration structures 440 on the upper surface 404 with a protruding gasket registration structure positioned at each corner of the upper surface, forming a square pattern. The gasket 414 can include four openings 438 extending through the thickness of the gasket, such that each of the protruding gasket registration structures 440 extends through a corresponding opening 438 when the gasket 414 is engaged with the base 402.

As shown in FIG. 4B, in some embodiments, the base 402 includes one or more alignment features 442. In some aspects, the one or more alignment features 442 align the gasket 414 on the base 402. In some aspects, the one or more alignment features 442 align the cover 424 on the base 402. In some embodiments, the alignment feature 442 is a protrusion (e.g., rectangular protrusion) extending from the upper surface 404 of the base 402. For example, and without limitation, a pair of alignment features 442 extending from the upper surface 404 can be positioned near opposing sides of the base 402. In another example, four alignment features 442 extending from the upper surface 404 can each be positioned near sides of the base 402 and spaced apart such that an edge of each of the alignment features 442 contacts an edge of the gasket 414 and cover 424 when they are positioned between alignment features (e.g., as shown in FIG. 4B).

In some embodiments, the base 402 is engaged with at least a portion of the gasket 414 using a fastening mechanism (e.g., fasteners such as screw, nut, washer, bolt). In some embodiments, the base 402 is engaged with at least a portion of the gasket 414 using magnets. In some embodiments, the base 402 is engaged with at least a portion of the gasket 414 using clamps.

In some embodiments, a well wall (e.g., a lightweight gasket) is disposed on the cover 424 such that the well wall and cover 424 form an open well capable of containing a predetermined amount of fluid. The well wall includes at least one side wall, forming an enclosed structure (e.g., a rectangular structure) with an open top end and an open bottom end. The bottom end of the well wall rests on the cover 424, with the side walls extending upwardly from the top cover, thereby defining an open well through which a liquid dispensing mechanism can dispense a buffer reagent (e.g., imaging buffer, immersion buffer). In some embodiments, the well wall has an inner wall angle that matches an angle of an imaging device (e.g., objective lens part of an optical system in an optofluidic instrument).

In accordance with another aspect of the disclosure, the cover and or gasket components can be designed as single-use, consumable or disposable members of the assembly; with the base, top, and/or substrate being designed for multiple uses (with cleaning or sterilization processes between uses).

### Exemplary workflow of assembly 100, 400

Liquid reagents are flowed from the fluidic inlet (e.g., fluidic inlet 128, fluidic inlet 426), through the closed flow cell, and out through the fluidic outlet (e.g., fluidic inlet 130, fluidic inlet 429). The replacement of a liquid reagent (e.g., imaging buffer) with another liquid reagent (e.g., fluorescently tagged oligonucleotides) can be referred to as a fluid exchange. Following a fluid exchange, the sample can be incubated on the substrate (e.g., substrate 102, 412). In some embodiments, a second liquid reagent can be flowed through the flow cell after the first liquid reagent. In some embodiments, multiple liquid reagents can be sequentially flowed one after another through the closed flow cell prior to incubation of the sample. During an incubation, the liquid reagent can remain disposed within the closed flow cell for a specified period of time. A heating element and/or cooling element can be removably coupled to the assembly (e.g., assembly 100, 400), heating or cooling the sample as necessary. Additionally or alternatively, the liquid reagent can be heated or cooled prior to flowing through the closed flow cell. During incubation, the liquid displacement mechanism can be deactivated.

Multiple fluid exchanges and incubations can be performed. Each fluid exchange can adjust the chemical environment, while subsequent incubations can facilitate reactions or interactions with the sample. By way of example, different liquid reagents can be exchanged individually, with an incubation occurring after each exchange. In another example, the same liquid reagent can be exchanged and incubated multiple times with a given sample. In some embodiments, the same liquid reagent can be exchanged multiple times before incubation. In some embodiments, the same liquid reagent is exchanged only once prior to incubation, followed by a subsequent exchange after incubation. Washing buffers can be flowed through the closed flow cell between fluid exchanges and/or incubations to remove unbound substances, contaminants, salt build-ups, or excess reagents.

In some embodiments, the sample is imaged using an imaging device. An objective lens can be positioned above the cover of the assembly (e.g., above the cover 424, above the above cover 106). The objective lens can move along the x-, y-, and z- axes, enabling traversal of the imageable area of the cover. In some embodiments, the open well (e.g., defined by the cover 106 and the wall 126) is filled with a buffer reagent (e.g., using a reagent dispensing mechanism). In some embodiments, the objective lens extends within the open well. In some embodiments, the objective lens (e.g., water immersion objective) is immersed within a buffer reagent (e.g., imaging buffer, immersion buffer) contained in the open well. Additional buffer reagent (e.g., imaging buffer, immersion buffer) can be added to the open well, if needed, so that the objective can be immersed in the reagent during imaging. Reagent (e.g., imaging buffer) can be disposed within the fluidic channel during imaging of the sample.

### Methods of assembling a reversible flow cell

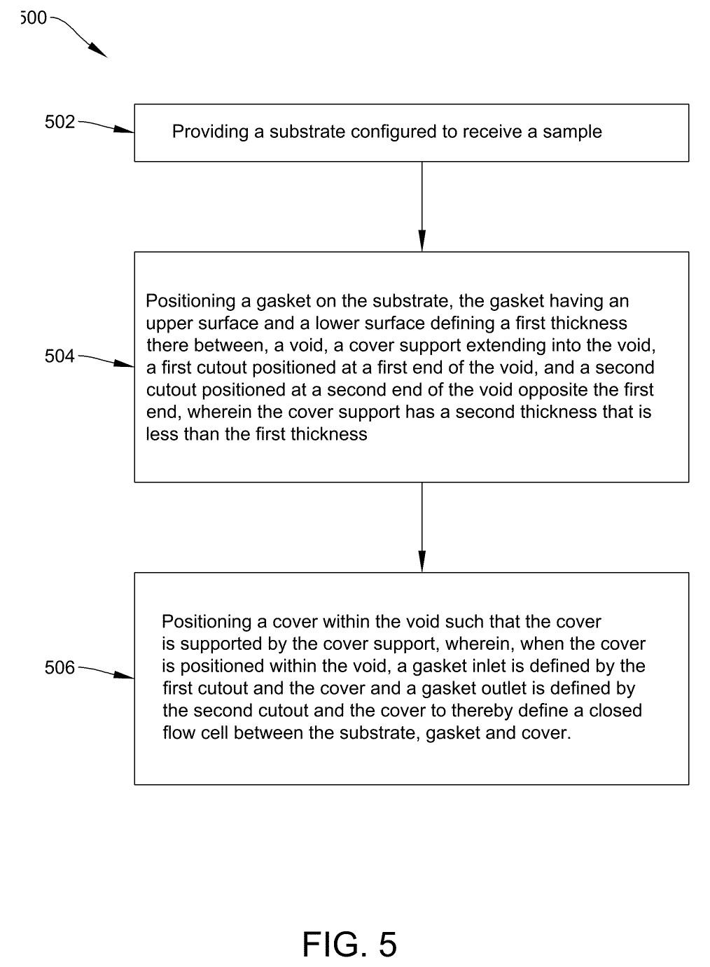

FIG. 5 is a flowchart illustrating a method 500 for assembling a reversible closed flow cell (e.g., for assembling the reversible flow cell of assembly 100). Method 500 (i.e., steps 502-506) may be completed in the order as listed or any suitable sequence. In step 502, a substrate (e.g., substrate 102) configured to receive a sample (e.g., a biological tissue sample, a hydrogel having a multiple molecular target) is provided. In step 504, a gasket (e.g., gasket 104) is positioned on the substrate. The gasket has an upper surface and a lower surface defining a first thickness therebetween, a void, a cover support (e.g., cover support 118) extending into the void, a first cutout (e.g., first cutout 114) positioned at a first end of the void, and a second cutout (e.g., second cutout 116) positioned at a second end of the void opposite the first end. At least one of the plurality of cover supports has a second thickness that is less than the first thickness. In step 506, a cover (e.g., cover 106) is positioned within the void such that the cover is supported by the cover support. When the cover is positioned within the void, a gasket inlet (e.g., gasket inlet 304) is defined by the first cutout and the cover, and a gasket outlet is defined by the second cutout and the cover to thereby define a closed flow cell between the substrate, gasket, and cover.

In some embodiments, the method 500 includes positioning a base (e.g., base 120) beneath the substrate such that the upper surface of the base receives the substrate. The base has an upper surface and a lower surface defining a thickness therebetween. In some embodiments, the method 500 includes positioning a top (e.g., top 122) over the cover. The top has an upper surface and a lower surface defining a thickness therebetween. The top is configured to removably couple to the base and includes at least one opening (e.g., opening 124) extending through the upper surface and lower surface with at least one downwardly extending wall (e.g., wall 126) disposed around a perimeter of the opening. In some embodiments, the method 500 includes engaging the top with the base. The cover extends across the opening in the top. In some embodiments, the top includes a plurality of snap joints at opposite sides thereof, the snap joints configured to removably couple the top to corresponding lugs of the base with the substrate, gasket and cover fixedly disposed therebetween. In some embodiments, engaging the top with the base includes engaging snap joints (e.g., snap joints 134) of the top with lugs (e.g., lugs 140) of the base.

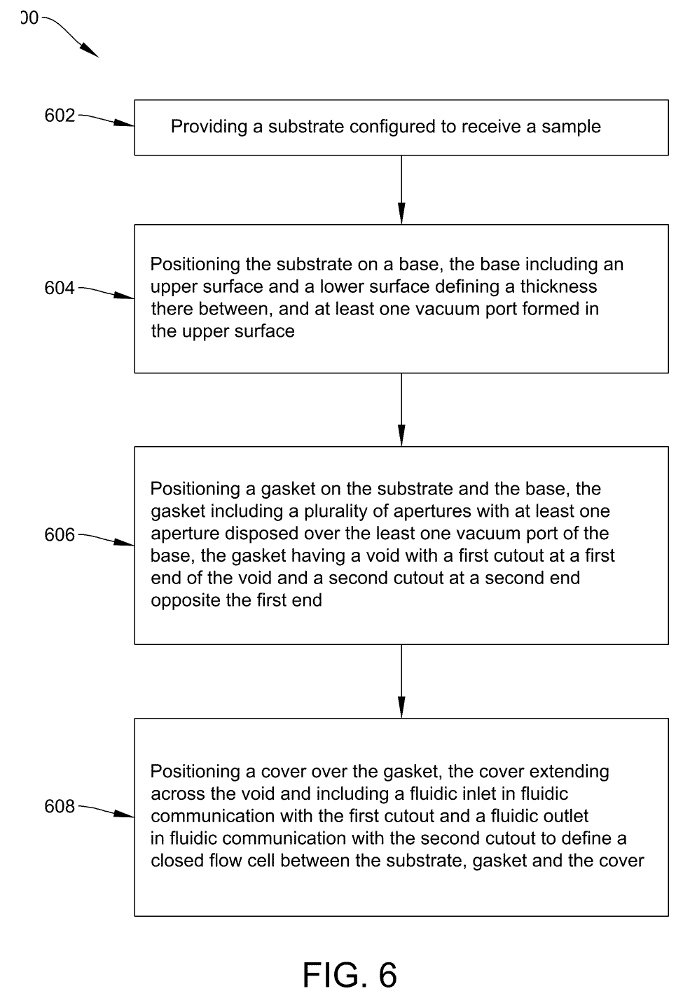

FIG. 6 is a flowchart illustrating a method 600 for assembling a reversible closed flow cell (e.g., for assembling the reversible flow cell of assembly 400). Method 600 (i.e., steps 602-608) may be completed in the order as listed or any suitable sequence. In step 602, a substrate (e.g., substrate 412) configured to receive a sample (e.g., biological tissue sample, a hydrogel having a multiple molecular target) is provided. In step 604, the substrate is positioned on a base (e.g., base 402). The base includes an upper surface and a lower surface defining a thickness therebetween, and at least one vacuum port (e.g., vacuum port 408) formed in the upper surface.

In step 606, a gasket (e.g., gasket 414) is positioned on the substrate and the base. The gasket includes multiple apertures (e.g., aperture 416) with at least one aperture disposed over the at least one vacuum port. The gasket has a void (e.g., void 418) with a first cutout (e.g., first cutout 420) at a first end of the void and a second cutout (e.g., second cutout 422) at a second end of the void, where the second end is opposite the first end. In some embodiments, the base includes at least one protruding gasket registration structure (e.g., protruding gasket registration structure 440) configured to engage at least a portion of the gasket. In some embodiments, positioning the gasket on the substrate and the base includes engaging the gasket with the at least one protruding gasket registration structure.

In step 608, a cover (e.g., cover 424) is positioned over the gasket such that the cover extends across the void. The cover includes a fluidic inlet (e.g., fluidic inlet 426) in fluidic communication with the first cutout and fluidic outlet (e.g., fluidic outlet 428) in fluidic communication with the second cutout to define a closed flow cell between the substrate, gasket, and cover.

In some embodiments, the base includes a pump port (e.g., pump port 410) in fluidic communication with the at least one vacuum port. In some embodiments, the method 600 includes coupling a vacuum pump to the base.

The flow devices of the disclosure may include any suitable material, for example, polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof.

In some embodiments, the present devices may be assembled by alignment and stacking of the slide, tissue sample, fluidic interface layer, gasket, and adaptor. For example, the adaptor may be aligned with and placed onto the fluidic interface layer, or the adapter can be placed on the slide prior to dispensing the fluidic interface layer of reagent(s). Compression may be applied during assembly such that the fluidic interface layer, gasket, and/or substrate layer are reversibly attached. Assembly, and disassembly, can be performed manually.

### Surface Properties

A surface of the device may include a material, coating, or surface texture that determines the physical properties of the device. In particular, the flow of liquids may be controlled by the surface properties (e.g., wettability of a liquid-contacting surface). In some cases, a portion (e.g., a flow path) may have a surface having a wettability suitable for facilitating liquid flow (e.g., in a flow path).

Wetting, which is the ability of a liquid to maintain contact with a solid surface, may be measured as a function of a water contact angle. A water contact angle of a material can be measured by any suitable method known in the art, such as the static sessile drop method, pendant drop method, dynamic sessile drop method, dynamic Wilhelmy method, single-fiber Wilhelmy method, single-fiber meniscus method, and Washburn's equation capillary rise method.

For example, portions of the device carrying aqueous phases (e.g., a channel or flow path) may have a surface material or coating that is hydrophilic or more hydrophilic than the other parts of the device, e.g., include a material or coating having a water contact angle of less than or equal to about 90°, and/or other components of the device may have a surface material or coating that is hydrophobic or more hydrophobic than the flow path, e.g., include a material or coating having a water contact angle of greater than 70° (e.g., greater than 90°, greater than 95°, greater than 100° (e.g., 95°-120° or 100°-10°)). The system can be designed to have a single type of material or coating throughout. Surface textures may also be employed to control fluid flow.

The surface properties may be those of a native surface (i.e., the surface properties of the bulk material used for fabrication) or of a surface treatment. Non-limiting examples of surface treatments include, e.g., surface coatings and surface textures. In one approach, the surface properties are attributable to one or more surface coatings present in a portion. Hydrophobic coatings may include fluoropolymers (e.g., AQUAPEL® glass treatment), silanes, siloxanes, silicones, or other coatings known in the art. Other coatings include those vapor deposited from a precursor such as henicosyl-1,1,2,2-tetrahydrododecyldimethyltris(dimethylaminosilane); henicosyl-1,1,2,2-tetrahydrododecyltrichlorosilane (C12); heptadecafluoro-1,1,2,2-tetrahydrodecyltrichlorosilane (C10); nonafluoro-1,1,2,2-tetrahydrohexyltris(dimethylamino)silane; 3,3,3,4,4,5,5,6,6-nonafluorohexyltrichlorosilane; tridecafluoro-1,1,2,2-tetrahydrooctyltrichlorosilane (C8); bis(tridecafluoro-1,1,2,2-tetrahydrooctyl)dimethylsiloxymethylchlorosilane; nonafluorohexyltriethoxysilane (C6); dodecyltrichlorosilane (DTS); dimethyldichlorosilane (DDMS); or 10-undecenyltrichlorosilane (V11); pentafluorophenylpropyltrichlorosilane (C5). Hydrophilic coatings include polymers such as polysaccharides, polyethylene glycol, polyamines, and polycarboxylic acids. Hydrophilic surfaces may also be created by oxygen plasma treatment of certain materials.

A coated surface may be formed by depositing a metal oxide onto a surface of the system. Example metal oxides useful for coating surfaces include, but are not limited to, Al2O3, TiO2, SiO2, or a combination thereof. Other metal oxides useful for surface modifications are known in the art. The metal oxide can be deposited onto a surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al2O3 can be deposited on a surface by contacting it with trimethylaluminum (TMA) and water.

In another approach, the surface properties may be attributable to surface texture. For example, a surface may have a nanotexture, e.g., have a surface with nanometer surface features, such as cones or columns, that alters the wettability of the surface. Nanotextured surface may be hydrophilic, hydrophobic, or superhydrophobic, e.g., have a water contact angle greater than 150°. Exemplary superhydrophobic materials include Manganese Oxide Polystyrene (MnO2/PS) nano-composite, Zinc Oxide Polystyrene (ZnO/PS) nano-composite, Precipitated Calcium Carbonate, Carbon nano-tube structures, and a silica nano-coating. Superhydrophobic coatings may also include a low surface energy material (e.g., an inherently hydrophobic material) and a surface roughness (e.g., using laser ablation techniques, plasma etching techniques, or lithographic techniques in which a material is etched through apertures in a patterned mask). Examples of low surface energy materials include fluorocarbon materials, e.g., polytetrafluoroethylene (PTFE), fluorinated ethylene propylene (FEP), ethylene tetrafluoroethylene (ETFE), ethylene chloro-trifluoroethylene (ECTFE), perfluoro-alkoxyalkane (PFA), poly(chloro-trifluoro-ethylene) (CTFE), perfluoro-alkoxyalkane (PFA), and poly(vinylidene fluoride) (PVDF). Other superhydrophobic surfaces are known in the art.

In some cases, the water contact angle of a hydrophilic or more hydrophilic material or coating is less than or equal to about 90°, e.g., less than 80°, 70°, 60°, 50°, 40°, 30°, 20°, or 10°, e.g., 90°, 85°, 80°, 75°, 70°, 65°, 60°, 55°, 50°, 45°, 40°, 35°, 30°, 25°, 20°, 15°, 10°, 9°, 8°, 7°, 6°, 5°, 4°, 3°, 2°, 1°, or 0°. In some cases, the water contact angle of a hydrophobic or more hydrophobic material or coating is at least 70°, e.g., at least 80°, at least 85°, at least 90°, at least 95°, or at least 100° (e.g., about 100°, 101°, 102°, 103°, 104°, 105°, 106°, 107°, 108°, 109°, 110°, 115°, 120°, 125°, 130°, 135°, 140°, 145°, or about) 150°.

The difference in water contact angles between that of a hydrophilic or more hydrophilic material or coating and a hydrophobic or more hydrophobic material or coating may be 5° to 100°, e.g., 5° to 80°, 5° to 60°, 5° to 50°, 5° to 40°, 5° to 30°, 5° to 20°, 10° to 75°, 15° to 70°, 20° to 65°, 25° to 60°, 30 to 50°, 35° to 45°, e.g., 5°, 6°, 7°, 8°, 9°, 10°, 15°, 20°, 25°, 30°, 35°, 40°, 45°, 50°, 55°, 60, 65°, 70°, 75°, 80°, 85°, 90°, 95°, or 100°.

Surfaces may also be coated with various functional materials, e.g., metals or other electrically or magnetically conducting materials. For example, a surface may include a metal coating for electrical connectivity, detection, or resistive heating. Alternatively, such elements may be physically incorporated into a device or placed in physical contact with a device.

Surface properties may also be modified after application. Such methods include exposure to UV, ozone, plasma (e.g., oxygen, argon, etc.), UV photografting and UV induced photo-catalytic oxidation. These and other methods can alter the properties of the surface (e.g., wettability such as hydrophilicity, fluorophilicity, or hydrophobicity) or add an additional layer (e.g., biomolecules) to the surface.

The above discussion centers on the water contact angle. It will be understood that liquids employed may not be water, or even aqueous. Accordingly, the actual contact angle of a liquid on a surface may differ from the water contact angle. Furthermore, the determination of a water contact angle of a material or coating can be made on that material or coating when not incorporated into a device.

### Methods of Detection

In some embodiments, the methods described herein include detecting, e.g., tissue, cells, particulate components thereof, or other analytes. A sensor (e.g., optical, electrical, magnetic, impedance, or fluorescent sensor) in the detector may sense a particular feature (e.g., fluorescence, charge) or characteristic (e.g., diameter or volume) of sample (e.g., a cell or group of cells in a tissue sample).

Methods of detection include optical detection, e.g., by visual observation, e.g., using an optical bright-field. In some embodiments, analytes thereof are detectable by light absorbance, scatter, emission, and/or transmission. Additionally, or alternatively, optical detection can include fluorescent detection, e.g., by fluorescent microscopy. In still further embodiments, methods of the disclosure include detection of analytes having electrical or magnetic labels or properties. In some embodiments, the device includes a plurality (e.g., 2, 3, 4, 5, 6, 7, 8, 9, 10, or more) of detectors. Detectors may or may not be integrated with the device. In some embodiments, the substrate layer and/or fluid interface layer may be transparent, or include transparent portions, e.g., to allow for visualization, imaging, or detection. Substrate layers or fluidic interface layers, or portions thereof, may include transparent materials such as glass, quartz, polystyrene, polyethylene terephthalate, etc. The detection methods described herein may be automated, e.g., including robotic systems.

A variety of analytes, e.g., tissue, cell, or particulate component or macromolecular constituent thereof, characteristics can be observed and/or quantified. For example, characteristics such as analyte, e.g., cell, or particulate component or macromolecular constituent thereof, size (e.g., diameter) and shape can be readily observed visually and recorded by image or video acquisition software known in the art. In addition, the number of analytes, e.g., cell or particulate component thereof, can similarly be observed visually, by using detectable labels, or by other optical characteristics (e.g., scatter, absorbance, transmission, emission, such as fluorescence, etc.). In some embodiments, methods of the disclosure include observing the presence and/or intensity of a fluorescently or ionically tagged antigen-binding molecule bound to a biological antigen (e.g., a protein or nucleic acid, e.g., associated with an intact cell).

### Preparation of Samples

A variety of steps can be performed to prepare a biological tissue sample for analysis. In some embodiments, a sample is collected or deposited in the device described herein and prepared using a device described herein. In some embodiments, a prepared sample is placed on a substrate layer described herein. Except where indicated otherwise, the preparative steps described below can generally be combined in any manner to appropriately prepare a particular sample for analysis. In some aspects, any of the preparative or processing steps described can be performed on a sample using a device described herein, e.g., to deliver reagents via a fluid source. For example, the preparing or processing may include but is not limited to steps for fixing, embedding, staining, crosslinking, permeabilizing the sample, providing and/or removing reagents (e.g., probes, enzymes, buffers, etc.) or any combinations thereof.

A biological tissue sample can be harvested from a subject (e.g., via surgical biopsy, whole subject sectioning), grown in vitro on a growth substrate or culture dish as a population of cells, or prepared as a tissue slice or tissue section. Grown samples may be sufficiently thin for analysis without further processing steps. Alternatively, grown samples, and samples obtained via biopsy or sectioning, can be prepared as thin tissue sections using a mechanical cutting apparatus such as a vibrating blade microtome. As another alternative, in some embodiments, a thin tissue section can be prepared by applying a touch imprint of a biological sample to a suitable substrate material.

The thickness of the tissue section can be a fraction of (e.g., less than 0.9, 0.8, 0.7, 0.6, 0.5, 0.4, 0.3, 0.2, or 0.1) the maximum cross-sectional dimension of a cell. However, tissue sections having a thickness that is larger than the maximum cross-section cell dimension can also be used. For example, cryostat sections can be used, which can be, e.g., from about 10 μm to about 20 μm thick.

More generally, the thickness of a tissue section typically depends on the method used to prepare the section and the physical characteristics of the tissue, and therefore sections having a wide variety of different thicknesses can be prepared and used. For example, the thickness of the tissue section can be at least 0.1, 0.2, 0.3, 0.4, 0.5, 0.7, 1.0, 1.5, 2, 3, 4, 5, 6, 7, 8, 9, 10, 12, 13, 14, 15, 20, 30, 40, or 50 μm. Thicker sections can also be used if desired or convenient, e.g., at least 70, 80, 90, or 100 μm or more. Typically, the thickness of a tissue section is about 1-100 μm, 1-50 μm, 1-30 μm, 1-25 μm, 1-20 μm, 1-15 μm, 1-10 μm, 2-8 μm, 3-7 μm, or 4-6 μm, but as mentioned above, sections with thicknesses larger or smaller than these ranges can also be analyzed.

Multiple sections can also be obtained from a single biological sample. For example, multiple tissue sections can be obtained from a surgical biopsy sample by performing serial sectioning of the biopsy sample using a sectioning blade. Spatial information among the serial sections can be preserved in this manner, and the sections can be analyzed successively to obtain three-dimensional information about the biological sample.

In some embodiments, the biological tissue sample (e.g., a tissue section as described above) can be prepared by deep freezing at a temperature suitable to maintain or preserve the integrity (e.g., the physical characteristics) of the tissue structure. Such a temperature can be, e.g., less than −20° C., or less than −25° C., −30° C., −40° C., −50° C., −60° C., −70° C., 80° C. −90° C., −100° C., −110° C., −120° C., −130° C., −140° C., −150° C., −160° C., −170° C., −180° C., −190° C., or −200° C. The frozen tissue sample can be sectioned, e.g., thinly sliced, onto a substrate surface using any number of suitable methods. For example, a tissue sample can be prepared using a chilled microtome (e.g., a cryostat) set at a temperature suitable to maintain both the structural integrity of the tissue sample and the chemical properties of the nucleic acids in the sample. Such a temperature can be, e.g., less than −15° C., less than −20° C., or less than −25° C. A sample can be snap frozen in isopentane and liquid nitrogen. Frozen samples can be stored in a sealed container prior to embedding.

### Fixation and Postfixation

In some embodiments, the biological sample can be prepared using formalin-fixation and paraffin-embedding (FFPE), which are established methods. In some embodiments, cell suspensions and other non-tissue samples can be prepared using formalin-fixation and paraffin-embedding. Following fixation of the sample and embedding in a paraffin or resin block, the sample can be sectioned as described above. Prior to analysis, the paraffin-embedding material can be removed from the tissue section (e.g., deparaffinization) by incubating the tissue section in an appropriate solvent (e.g., xylene) followed by a rinse (e.g., 99.5% ethanol for 2 minutes, 96% ethanol for 2 minutes, and 70% ethanol for 2 minutes).

As an alternative to formalin fixation described above, a biological sample can be fixed in any of a variety of other fixatives to preserve the biological structure of the sample prior to analysis. For example, a sample can be fixed via immersion in ethanol, methanol, acetone, paraformaldehyde (PFA)-Triton, and combinations thereof.

In some embodiments, acetone fixation is used with fresh frozen samples, which can include, but are not limited to, cortex tissue, mouse olfactory bulb, human brain tumor, human post-mortem brain, and breast cancer samples. When acetone fixation is performed, pre- permeabilization steps (described below) may not be performed. Alternatively, acetone fixation can be performed in conjunction with permeabilization steps.

In some embodiments, the methods provided herein includes one or more post-fixing (also referred to as postfixation) steps. In some embodiments, one or more post-fixing step is performed after contacting a sample with a polynucleotide disclosed herein, e.g., one or more probes such as a circular or padlock probe. In some embodiments, one or more post-fixing step is performed after a hybridization complex including a probe and a target is formed in a sample. In some embodiments, one or more post-fixing step is performed prior to a ligation reaction disclosed herein, such as the ligation to circularize a padlock probe.

In some embodiments, one or more post-fixing step is performed after contacting a sample with a binding or labelling agent (e.g., an antibody or antigen binding fragment thereof) for a non-nucleic acid analyte such as a protein analyte. The labelling agent can include a nucleic acid molecule (e.g., reporter oligonucleotide) including a sequence corresponding to the labelling agent and therefore corresponds to (e.g., uniquely identifies) the analyte. In some embodiments, the labelling agent can include a reporter oligonucleotide including one or more barcode sequences.

A post-fixing step may be performed using any suitable fixation reagent disclosed herein, for example, 3% (w/v) paraformaldehyde in DEPC-PBS.

### Embedding

As an alternative to paraffin embedding described above, a biological sample can be embedded in any of a variety of other embedding materials to provide structural substrate to the sample prior to sectioning and other handling steps. In some cases, the embedding material can be removed e.g., prior to analysis of tissue sections obtained from the sample. Suitable embedding materials include, but are not limited to, waxes, resins (e.g., methacrylate resins), epoxies, and agar.

In some embodiments, the biological sample can be embedded in a matrix (e.g., a hydrogel matrix). Embedding the sample in this manner typically involves contacting the biological sample with a hydrogel such that the biological sample becomes surrounded by the hydrogel. For example, the sample can be embedded by contacting the sample with a suitable polymer material, and activating the polymer material to form a hydrogel. In some embodiments, the hydrogel is formed such that the hydrogel is internalized within the biological sample.

In some embodiments, the biological sample is immobilized in the hydrogel via cross-linking of the polymer material that forms the hydrogel. Cross-linking can be performed chemically and/or photochemically, or alternatively by any other hydrogel-formation method known in the art.

The composition and application of the hydrogel-matrix to a biological sample typically depends on the nature and preparation of the biological sample (e.g., sectioned, non-sectioned, type of fixation). As one example, where the biological sample is a tissue section, the hydrogel-matrix can include a monomer solution and an ammonium persulfate (APS) initiator/tetramethylethylenediamine (TEMED) accelerator solution. As another example, where the biological sample consists of cells (e.g., cultured cells or cells disassociated from a tissue sample), the cells can be incubated with the monomer solution and APS/TEMED solutions. For cells, hydrogel-matrix gels are formed in compartments, including but not limited to devices used to culture, maintain, or transport the cells. For example, hydrogel-matrices can be formed with monomer solution plus APS/TEMED added to the compartment to a depth ranging from about 0.1 μm to about 2 mm.

Additional methods and aspects of hydrogel embedding of biological samples are described for example in Chen et al., Science 347(6221):543-548, 2015, the entire contents of which are incorporated herein by reference.

### Staining and Immunohistochemistry (INC)

To facilitate visualization, biological samples can be stained using a wide variety of stains and staining techniques. In some embodiments, for example, a sample can be stained using any number of stains and/or immunohistochemical reagents. One or more staining steps may be performed to prepare or process a biological sample for an assay described herein or may be performed during and/or after an assay. In some instances, the provided methods and devices for the reversible assembly and use of a flowcell allow access to the sample after performing fluidic operations. In some cases, the provided flowcell can be sealed then access can be gained to the sample without disrupting the sample (e.g., to perform staining or IHC after performing other fluidic steps of an assay). In some embodiments, the sample can be contacted with one or more nucleic acid stains, membrane stains (e.g., cellular or nuclear membrane), cytological stains, or combinations thereof. In some examples, the stain may be specific to proteins, phospholipids, DNA (e.g., dsDNA, ssDNA), RNA, an organelle or compartment of the cell. The sample may be contacted with one or more labeled antibodies (e.g., a primary antibody specific for the analyte of interest and a labeled secondary antibody specific for the primary antibody). In some embodiments, cells in the sample can be segmented using one or more images taken of the stained sample.

In some embodiments, the stain is performed using a lipophilic dye. In some examples, the staining is performed with a lipophilic carbocyanine or aminostyryl dye, or analogs thereof (e.g., Dil, DiO, DiR, DiD). Other cell membrane stains may include FM and RH dyes or immunohistochemical reagents specific for cell membrane proteins. In some examples, the stain may include but is not limited to, acridine orange, acid fuchsin, Bismarck brown, carmine, coomassie blue, cresyl violet, DAPI, eosin, ethidium bromide, acid fuchsine, haematoxylin, Hoechst stains, iodine, methyl green, methylene blue, neutral red, Nile blue, Nile red, osmium tetroxide, ruthenium red, propidium iodide, rhodamine (e.g., rhodamine B), or safranine, or derivatives thereof. In some embodiments, the sample may be stained with haematoxylin and eosin (H&E).

In some embodiments, biological samples can be destained. Methods of destaining or discoloring a biological sample are known in the art, and generally depend on the nature of the stain(s) applied to the sample. For example, in some embodiments, one or more immunofluorescent stains are applied to the sample via antibody coupling. Such stains can be removed using techniques such as cleavage of disulfide linkages via treatment with a reducing agent and detergent washing, chaotropic salt treatment, treatment with antigen retrieval solution, and treatment with an acidic glycine buffer. Methods for multiplexed staining and destaining are described, for example, in Bolognesi et al., J. Histochem. Cytochem. 2017; 65(8): 431-444, Lin et al., Nat Commun. 2015; 6:8390, Pirici et al., J. Histochem. Cytochem. 2009; 57:567-75, and Glass et al., J. Histochem. Cytochem. 2009; 57:899-905, the entire contents of each of which are incorporated herein by reference.

### Isometric Expansion

In some embodiments, a biological sample embedded in a matrix (e.g., a hydrogel) can be isometrically expanded. Isometric expansion methods that can be used include hydration, a preparative step in expansion microscopy, as described in Chen et al., Science 347(6221):543-548, 2015.

Isometric expansion can be performed by anchoring one or more components of a biological sample (e.g., nucleic acids, proteins) to a gel, followed by gel formation, proteolysis, and swelling. In some embodiments, analytes in the sample, products of the analytes, and/or probes associated with analytes in the sample can be anchored to the matrix (e.g., hydrogel). Isometric expansion of the biological sample can occur prior to immobilization of the biological sample on a substrate, or after the biological sample is immobilized to a substrate. In some embodiments, the isometrically expanded biological sample can be removed from the substrate prior to contacting the substrate with probes disclosed herein.

Isometric expansion of the sample can increase the spatial resolution of the subsequent analysis of the sample. The increased resolution in spatial profiling can be determined by comparison of an isometrically expanded sample with a sample that has not been isometrically expanded.

In some embodiments, a biological sample is isometrically expanded to a size at least 2×, 2.1×, 2.2×, 2.3×, 2.4×, 2.5×, 2.6×, 2.7×, 2.8×, 2.9×, 3×, 3.1×, 3.2×, 3.3×, 3.4×, 3.5×, 3.6×, 3.7×, 3.8×, 3.9×, 4×, 4.1×, 4.2×, 4.3×, 4.4×, 4.5×, 4.6×, 4.7×, 4.8×, or 4.9×its non-expanded size. In some embodiments, the sample is isometrically expanded to at least 2× and less than 20× of its non-expanded size.

### Crosslinking and De-Crosslinking

In some embodiments, the biological sample is reversibly cross-linked. In some aspects, the analytes, polynucleotides and/or product of an analyte or a probe bound thereto can be anchored to a polymer matrix. For example, the polymer matrix can be a hydrogel. In some embodiments, portions of the sample can be modified to contain functional groups that can be used as an anchoring site to attach the polynucleotide probes and/or amplification product to a polymer matrix. In some embodiments, a modified probe including oligo dT may be used to bind to mRNA molecules of interest, followed by reversible crosslinking of the mRNA molecules.

In some embodiments, a hydrogel can include hydrogel subunits, such as, but not limited to, acrylamide, bis-acrylamide, polyacrylamide and derivatives thereof, poly(ethylene glycol) and derivatives thereof (e.g. PEG-acrylate (PEG-DA), PEG-RGD), gelatin-methacryloyl (GeIMA), methacrylated hyaluronic acid (MeHA), polyaliphatic polyurethanes, polyether polyurethanes, polyester polyurethanes, polyethylene copolymers, polyamides, polyvinyl alcohols, polypropylene glycol, polytetramethylene oxide, polyvinyl pyrrolidone, polyacrylamide, poly(hydroxyethyl acrylate), and poly(hydroxyethyl methacrylate), collagen, hyaluronic acid, chitosan, dextran, agarose, gelatin, alginate, protein polymers, methylcellulose, and the like, and combinations thereof.

In some embodiments, a hydrogel includes a hybrid material, e.g., the hydrogel material includes elements of both synthetic and natural polymers. Examples of suitable hydrogels are described, for example, in U.S. Pat. Nos. 6,391,937, 9,512,422, and 9,889,422, and in U.S. Patent Application Publication Nos. 2017/0253918, 2018/0052081 and 2010/0055733, the entire contents of each of which are incorporated herein by reference.

In some embodiments, the hydrogel can form the substrate. In some embodiments, the substrate includes a hydrogel and one or more second materials. In some embodiments, the hydrogel is placed on top of one or more second materials. For example, the hydrogel can be pre-formed and then placed on top of, underneath, or in any other configuration with one or more second materials. In some embodiments, hydrogel formation occurs after contacting one or more second materials during formation of the substrate. Hydrogel formation can also occur within a structure (e.g., wells, ridges, projections, and/or markings) located on a substrate.

In some embodiments, hydrogel formation on a substrate occurs before, contemporaneously with, or after the sample is in the device. For example, hydrogel formation can be performed on the sample on the substrate layer.

In some embodiments, hydrogel formation occurs within a biological sample. In some embodiments, a biological sample (e.g., tissue section) is embedded in a hydrogel. In some embodiments, hydrogel subunits are infused into the biological sample, and polymerization of the hydrogel is initiated by an external or internal stimulus.

In embodiments in which a hydrogel is formed within a biological sample, functionalization chemistry can be used. In some embodiments, functionalization chemistry includes hydrogel-tissue chemistry (HTC). Any hydrogel-tissue backbone (e.g., synthetic or native) suitable for HTC can be used for anchoring biological macromolecules and modulating functionalization. Non-limiting examples of methods using HTC backbone variants include CLARITY, PACT, ExM, SWITCH and ePACT. In some embodiments, hydrogel formation within a biological sample is permanent. For example, biological macromolecules can permanently adhere to the hydrogel allowing multiple rounds of interrogation. In some embodiments, hydrogel formation within a biological sample is reversible.

In some embodiments, a method disclosed herein includes de-crosslinking the reversibly cross-linked biological sample. The de-crosslinking does not need to be complete. In some embodiments, only a portion of crosslinked molecules in the reversibly cross-linked biological sample are de-crosslinked and allowed to migrate.

### Tissue Permeabilization and Treatment

In some embodiments, a biological sample can be permeabilized to facilitate transfer of analytes out of the sample, and/or to facilitate transfer of species (such as probes) into the sample. If a sample is not permeabilized sufficiently, the amount of analyte captured from the sample may be too low to enable adequate analysis. Conversely, if the tissue sample is too permeable, the relative spatial relationship of the analytes within the tissue sample can be lost. Hence, a balance between permeabilizing the tissue sample enough to obtain good signal intensity while still maintaining the spatial resolution of the analyte distribution in the sample is desirable.

In general, a biological sample can be permeabilized by exposing the sample to one or more permeabilizing agents. Suitable agents for this purpose include, but are not limited to, organic solvents (e.g., acetone, ethanol, and methanol), cross-linking agents (e.g., paraformaldehyde), detergents (e.g., saponin, Triton X100™ or Tween-20™), and enzymes (e.g., trypsin, proteases). In some embodiments, the biological sample can be incubated with a cellular permeabilizing agent to facilitate permeabilization of the sample. Additional methods for sample permeabilization are described, for example, in Jamur et al., Method Mol. Biol. 588:63-66, 2010, the entire contents of which are incorporated herein by reference. Any suitable method for sample permeabilization can generally be used in connection with the samples described herein.

In some embodiments, the biological sample can be permeabilized by adding one or more lysis reagents to the sample. Examples of suitable lysis agents include, but are not limited to, bioactive reagents such as lysis enzymes that are used for lysis of different cell types, e.g., gram positive or negative bacteria, plants, yeast, mammalian, such as lysozymes, achromopeptidase, lysostaphin, labiase, kitalase, lyticase, and a variety of other commercially available lysis enzymes.

Other lysis agents can additionally or alternatively be added to the biological sample to facilitate permeabilization. For example, surfactant-based lysis solutions can be used to lyse sample cells. Lysis solutions can include ionic surfactants such as, for example, sarcosyl and sodium dodecyl sulfate (SDS). More generally, chemical lysis agents can include, without limitation, organic solvents, chelating agents, detergents, surfactants, and chaotropic agents.

In some embodiments, the biological sample can be permeabilized by non-chemical permeabilization methods. Non-chemical permeabilization methods are known in the art. For example, non-chemical permeabilization methods that can be used include, but are not limited to, physical lysis techniques such as electroporation, mechanical permeabilization methods (e.g., bead beating using a homogenizer and grinding balls to mechanically disrupt sample tissue structures), acoustic permeabilization (e.g., sonication), and thermal lysis techniques such as heating to induce thermal permeabilization of the sample.

Additional reagents can be added to a biological sample to perform various functions prior to analysis of the sample. In some embodiments, Dnase and Rnase inactivating agents or inhibitors such as proteinase K, and/or chelating agents such as EDTA, can be added to the sample. For example, a method disclosed herein may include a step for increasing accessibility of a nucleic acid for binding, e.g., a denaturation step to opening up DNA in a cell for hybridization by a probe. For example, proteinase K treatment may be used to free up DNA with proteins bound thereto.

### Analytes

The methods and compositions disclosed herein can be used to detect and analyze a wide variety of different analytes. In some aspects, an analyte can include any biological substance, structure, moiety, or component to be analyzed. In some aspects, a target disclosed herein may similarly include any analyte of interest. In some examples, a target or analyte can be directly or indirectly detected.

Analytes can be derived from a specific type of cell and/or a specific sub-cellular region. For example, analytes can be derived from cytosol, from cell nuclei, from mitochondria, from microsomes, and more generally, from any other compartment, organelle, or portion of a cell. Permeabilizing agents that specifically target certain cell compartments and organelles can be used to selectively release analytes from cells for analysis, and/or allow access of one or more reagents (e.g., probes for analyte detection) to the analytes in the cell or cell compartment or organelle.

The analyte may include any biomolecule or chemical compound, including a macromolecule such as a protein or peptide, a lipid or a nucleic acid molecule, or a small molecule, including organic or inorganic molecules. The analyte may be a cell or a microorganism, including a virus, or a fragment or product thereof. An analyte can be any substance or entity for which a specific binding partner (e.g., an affinity binding partner) can be developed. Such a specific binding partner may be a nucleic acid probe (for a nucleic acid analyte) and may lead directly to the generation of a product. Alternatively, the specific binding partner may be coupled to a nucleic acid, which may be detected.

Analytes of particular interest may include nucleic acid molecules, such as DNA (e.g., genomic DNA, mitochondrial DNA, plastid DNA, viral DNA, etc.) and RNA (e.g., mRNA, microRNA, rRNA, snRNA, viral RNA, etc.), and synthetic and/or modified nucleic acid molecules, (e.g., including nucleic acid domains including or consisting of synthetic or modified nucleotides such as LNA, PNA, morpholino, etc.), proteinaceous molecules such as peptides, polypeptides, proteins or prions or any molecule which includes a protein or polypeptide component, etc., or fragments thereof, or a lipid or carbohydrate molecule, or any molecule which include a lipid or carbohydrate component. The analyte may be a single molecule or a complex that contains two or more molecular subunits, e.g., including but not limited to protein-DNA complexes, which may or may not be covalently bound to one another, and which may be the same or different. Thus, in addition to cells or microorganisms, such a complex analyte may also be a protein complex or protein interaction. Such a complex or interaction may thus be a homo- or hetero-multimer. Aggregates of molecules, e.g., proteins may also be target analytes, for example aggregates of the same protein or different proteins. The analyte may also be a complex between proteins or peptides and nucleic acid molecules such as DNA or RNA, e.g., interactions between proteins and nucleic acids, e.g., regulatory factors, such as transcription factors, and DNA or RNA.

### Endogenous Analytes

In some embodiments, an analyte herein is endogenous to a biological sample and can include nucleic acid analytes and non-nucleic acid analytes. Methods and compositions disclosed herein can be used to analyze nucleic acid analytes (e.g., using a nucleic acid probe or probe set that directly or indirectly hybridizes to a nucleic acid analyte) and/or non-nucleic acid analytes (e.g., using a labelling agent that includes a reporter oligonucleotide and binds directly or indirectly to a non-nucleic acid analyte) in any suitable combination.

Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral coat proteins, extracellular and intracellular proteins, antibodies, and antigen binding fragments.

Examples of nucleic acid analytes include DNA analytes such as single-stranded DNA (ssDNA), double-stranded DNA (dsDNA), genomic DNA, methylated DNA, specific methylated DNA sequences, fragmented DNA, mitochondrial DNA, in situ synthesized PCR products, and RNA/DNA hybrids. The DNA analyte can be a transcript of another nucleic acid molecule (e.g., DNA or RNA such as mRNA) present in a tissue sample.

Examples of nucleic acid analytes also include RNA analytes such as various types of coding and non-coding RNA. Examples of the different types of RNA analytes include messenger RNA (mRNA), including a nascent RNA, a pre-mRNA, a primary-transcript RNA, and a processed RNA, such as a capped mRNA (e.g., with a 5′ 7-methyl guanosine cap), a polyadenylated mRNA (poly-A tail at the 3′ end), and a spliced mRNA in which one or more introns have been removed. Also included in the analytes disclosed herein are non-capped mRNA, a non-polyadenylated mRNA, and a non-spliced mRNA. The RNA analyte can be a transcript of another nucleic acid molecule (e.g., DNA or RNA such as viral RNA) present in a tissue sample. Examples of a non-coding RNAs (ncRNA) that is not translated into a protein include transfer RNAs (tRNAs) and ribosomal RNAs (rRNAs), as well as small non-coding RNAs such as microRNA (miRNA), small interfering RNA (siRNA), Piwi-interacting RNA (piRNA), small nucleolar RNA (snoRNA), small nuclear RNA (snRNA), extracellular RNA (exRNA), small Cajal body-specific RNAs (scaRNAs), and the long ncRNAs such as Xist and HOTAIR.

In some embodiments described herein, an analyte may be a denatured nucleic acid, wherein the resulting denatured nucleic acid is single-stranded. The nucleic acid may be denatured, for example, optionally using formamide, heat, or both formamide and heat. In some embodiments, the nucleic acid is not denatured for use in a method disclosed herein.

In certain embodiments, an analyte can be extracted from a live cell. Processing conditions can be adjusted to ensure that a biological sample remains live during analysis, and analytes are extracted from (or released from) live cells of the sample. Live cell-derived analytes can be obtained only once from the sample or can be obtained at intervals from a sample that continues to remain in viable condition.

Methods and compositions disclosed herein can be used to analyze any number of analytes. For example, the number of analytes that are analyzed can be at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 25, at least about 30, at least about 40, at least about 50, at least about 100, at least about 1,000, at least about 10,000, at least about 100,000 or more different analytes present in a region of the sample or within an individual feature of the substrate.

In any embodiment described herein, the analyte includes a target sequence. In some embodiments, the target sequence may be endogenous to the sample, generated in the sample, added to the sample, or associated with an analyte in the sample. In some embodiments, the target sequence is a single-stranded target sequence (e.g., a sequence in a rolling circle amplification product). In some embodiments, the analytes include one or more single-stranded target sequences. In one aspect, a first single-stranded target sequence is not identical to a second single-stranded target sequence. In another aspect, a first single-stranded target sequence is identical to one or more second single-stranded target sequence. In some embodiments, the one or more second single-stranded target sequence is included in the same analyte (e.g., nucleic acid) as the first single-stranded target sequence. Alternatively, the one or more second single-stranded target sequence is included in a different analyte (e.g., nucleic acid) from the first single-stranded target sequence.

### Labelling Agents

In some embodiments, provided herein are methods and compositions for analyzing endogenous analytes (e.g., RNA, ssDNA, and cell surface or intracellular proteins and/or metabolites) in a sample using one or more labelling agents. In some embodiments, an analyte labelling agent may include an agent that interacts with an analyte (e.g., an endogenous analyte in a sample). In some embodiments, the labelling agents can include a reporter oligonucleotide that is indicative of the analyte or portion thereof interacting with the labelling agent. For example, the reporter oligonucleotide may include a barcode sequence that permits identification of the labelling agent. In some cases, the sample contacted by the labelling agent can be further contacted with a probe (e.g., a single-stranded probe sequence), that hybridizes to a reporter oligonucleotide of the labelling agent, in order to identify the analyte associated with the labelling agent. In some embodiments, the analyte labelling agent includes an analyte binding moiety and a labelling agent barcode domain including one or more barcode sequences, e.g., a barcode sequence that corresponds to the analyte binding moiety and/or the analyte. An analyte binding moiety barcode includes a barcode that is associated with or otherwise identifies the analyte binding moiety. In some embodiments, by identifying an analyte binding moiety by identifying its associated analyte binding moiety barcode, the analyte to which the analyte binding moiety binds can also be identified. An analyte binding moiety barcode can be a nucleic acid sequence of a given length and/or sequence that is associated with the analyte binding moiety. An analyte binding moiety barcode can generally include any of the variety of aspects of barcodes described herein.

In some embodiments, the method includes one or more post-fixing (also referred to as post-fixation) steps after contacting the sample with one or more labelling agents.

In the methods and devices described herein, one or more labelling agents capable of binding to or otherwise coupling to one or more features may be used to characterize analytes, cells and/or cell features. In some instances, cell features include cell surface features. Analytes may include, but are not limited to, a protein, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, a gap junction, an adherens junction, or any combination thereof. In some instances, cell features may include intracellular analytes, such as proteins, protein modifications (e.g., phosphorylation status or other post-translational modifications), nuclear proteins, nuclear membrane proteins, or any combination thereof.

In some embodiments, an analyte binding moiety may include any molecule or moiety capable of binding to an analyte (e.g., a biological analyte, e.g., a macromolecular constituent). A labelling agent may include, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. The labelling agents can include (e.g., are attached to) a reporter oligonucleotide that is indicative of the cell surface feature to which the binding group binds. For example, the reporter oligonucleotide may include a barcode sequence that permits identification of the labelling agent. For example, a labelling agent that is specific to one type of cell feature (e.g., a first cell surface feature) may have coupled thereto a first reporter oligonucleotide, while a labelling agent that is specific to a different cell feature (e.g., a second cell surface feature) may have a different reporter oligonucleotide coupled thereto. For a description of exemplary labelling agents, reporter oligonucleotides, and methods of use, see, e.g., U.S. Pat. No. 10,550,429; U.S. Pat. Pub. 20190177800; and U.S. Pat. Pub. 20190367969, which are each incorporated by reference herein in their entirety.

In some embodiments, an analyte binding moiety includes one or more antibodies or antigen binding fragments thereof. The antibodies or antigen binding fragments including the analyte binding moiety can specifically bind to a target analyte. In some embodiments, the analyte is a protein (e.g., a protein on a surface of the biological sample (e.g., a cell) or an intracellular protein). In some embodiments, a plurality of analyte labelling agents including a plurality of analyte binding moieties bind a plurality of analytes present in a biological sample. In some embodiments, the plurality of analytes includes a single species of analyte (e.g., a single species of polypeptide). In some embodiments in which the plurality of analytes includes a single species of analyte, the analyte binding moieties of the plurality of analyte labelling agents are the same. In some embodiments in which the plurality of analytes includes a single species of analyte, the analyte binding moieties of the plurality of analyte labelling agents are the different (e.g., members of the plurality of analyte labelling agents can have two or more species of analyte binding moieties, wherein each of the two or more species of analyte binding moieties binds a single species of analyte, e.g., at different binding sites). In some embodiments, the plurality of analytes includes multiple different species of analyte (e.g., multiple different species of polypeptides).

In other instances, e.g., to facilitate sample multiplexing, a labelling agent that is specific to a particular cell feature may have a first plurality of the labelling agent (e.g., an antibody or lipophilic moiety) coupled to a first reporter oligonucleotide and a second plurality of the labelling agent coupled to a second reporter oligonucleotide.

In some aspects, these reporter oligonucleotides may include nucleic acid barcode sequences that permit identification of the labelling agent which the reporter oligonucleotide is coupled to. The selection of oligonucleotides as the reporter may provide advantages of being able to generate significant diversity in terms of sequence, while also being readily attachable to most biomolecules, e.g., antibodies, etc., as well as being readily detected, e.g., using sequencing or array technologies.

Attachment (coupling) of the reporter oligonucleotides to the labelling agents may be achieved through any of a variety of direct or indirect, covalent or non-covalent associations or attachments. For example, oligonucleotides may be covalently attached to a portion of a labelling agent (such a protein, e.g., an antibody or antibody fragment) using chemical conjugation techniques (e.g., Lightning-Link® antibody labelling kits available from Innova Biosciences), as well as other non-covalent attachment mechanisms, e.g., using biotinylated antibodies and oligonucleotides (or beads that include one or more biotinylated linker, coupled to oligonucleotides) with an avidin or streptavidin linker. Antibody and oligonucleotide biotinylation techniques are available. See, e.g., Fang, et al., “Fluoride-Cleavable Biotinylation Phosphoramidite for 5′-end-Labelling and Affinity Purification of Synthetic Oligonucleotides,” Nucleic Acids Res. Jan. 15, 2003; 31(2):708-715, which is entirely incorporated herein by reference for all purposes. Likewise, protein and peptide biotinylation techniques have been developed and are readily available. See, e.g., U.S. Pat. No. 6,265,552, which is entirely incorporated herein by reference for all purposes. Furthermore, click reaction chemistry may be used to couple reporter oligonucleotides to labelling agents. Commercially available kits, such as those from Thunderlink and Abcam, and techniques common in the art may be used to couple reporter oligonucleotides to labelling agents as appropriate. In another example, a labelling agent is indirectly (e.g., via hybridization) coupled to a reporter oligonucleotide including a barcode sequence that identifies the label agent. For instance, the labelling agent may be directly coupled (e.g., covalently bound) to a hybridization oligonucleotide that includes a sequence that hybridizes with a sequence of the reporter oligonucleotide. Hybridization of the hybridization oligonucleotide to the reporter oligonucleotide couples the labelling agent to the reporter oligonucleotide. In some embodiments, the reporter oligonucleotides are releasable from the labelling agent, such as upon application of a stimulus. For example, the reporter oligonucleotide may be attached to the labeling agent through a labile bond (e.g., chemically labile, photolabile, thermally labile, etc.) as generally described for releasing molecules from supports elsewhere herein. In some instances, the reporter oligonucleotides described herein may include one or more functional sequences that can be used in subsequent processing, such as an adapter sequence, a unique molecular identifier (UMI) sequence, a sequencer specific flow cell attachment sequence (such as an P5, P7, or partial P5 or P7 sequence), a primer or primer binding sequence, a sequencing primer or primer binding sequence (such as an R1, R2, or partial R1 or R2 sequence).

In some cases, the labelling agent can include a reporter oligonucleotide and a label. A label can be fluorophore, a radioisotope, a molecule capable of a colorimetric reaction, a magnetic particle, or any other suitable molecule or compound capable of detection. The label can be conjugated to a labelling agent (or reporter oligonucleotide) either directly or indirectly (e.g., the label can be conjugated to a molecule that can bind to the labelling agent or reporter oligonucleotide). In some cases, a label is conjugated to a first oligonucleotide that is complementary (e.g., hybridizes) to a sequence of the reporter oligonucleotide.

In some embodiments, multiple different species of analytes (e.g., polypeptides) from the biological sample can be subsequently associated with the one or more physical properties of the biological sample. For example, the multiple different species of analytes can be associated with locations of the analytes in the biological sample. Such information (e.g., proteomic information when the analyte binding moiety(ies) recognizes a polypeptide(s)) can be used in association with other spatial information (e.g., genetic information from the biological sample, such as DNA sequence information, transcriptome information (i.e., sequences of transcripts), or both). For example, a cell surface protein of a cell can be associated with one or more physical properties of the cell (e.g., a shape, size, activity, or a type of the cell). The one or more physical properties can be characterized by imaging the cell. The cell can be bound by an analyte labelling agent including an analyte binding moiety that binds to the cell surface protein and an analyte binding moiety barcode that identifies that analyte binding moiety. Results of protein analysis in a sample (e.g., a tissue sample or a cell) can be associated with DNA and/or RNA analysis in the sample.

### Products of Endogenous Analyte and/or Labelling Agent

In some embodiments, provided herein are methods and compositions for analyzing one or more products of an endogenous analyte and/or a labelling agent in a biological sample. In some embodiments, an endogenous analyte (e.g., a viral or cellular DNA or RNA) or a product (e.g., a hybridization product, a ligation product, an extension product (e.g., by a DNA or RNA polymerase), a replication product, a transcription/reverse transcription product, and/or an amplification product thereof is analyzed. In some aspects, the generation and/or processing of the analytes may be performed in the device and/or the analysis of the analytes may be performed in the device, such as by delivering reagents to a sample via a fluid source. For example, the generation, processing, and analysis may include but is not limited to reactions including hybridizations, ligations, binding, extension, amplifications, or other enzymatic reactions. In some embodiments, a labelling agent that directly or indirectly binds to an analyte in the biological sample is analyzed. In some embodiments, a product (e.g., a hybridization product, a ligation product, an extension product (e.g., by a DNA or RNA polymerase), a replication product, a transcription/reverse transcription product, and/or an amplification product of a labelling agent that directly or indirectly binds to an analyte in the biological sample is analyzed. In some embodiments, the reactions for generating any of the products (e.g., ligation, amplification, extension, hybridization) provided herein are performed in the devices provided herein.

### Hybridization

In some embodiments, a product of an endogenous analyte and/or a labelling agent is a hybridization product including the pairing of substantially complementary or complementary nucleic acid sequences within two different molecules, one of which is the endogenous analyte or the labelling agent (e.g., reporter oligonucleotide attached thereto). The other molecule can be another endogenous molecule or another labelling agent such as a probe. Pairing can be achieved by any process in which a nucleic acid sequence joins with a substantially or fully complementary sequence through base pairing to form a hybridization complex. For purposes of hybridization, two nucleic acid sequences are “substantially complementary” if at least 60% (e.g., at least 70%, at least 80%, or at least 90%) of their individual bases are complementary to one another.

### Probes

Various probes and probe sets can be hybridized to an endogenous analyte and/or a labelling agent and each probe may include one or more barcode sequences. Exemplary barcoded probes or probe sets may be based on a padlock probe, a gapped padlock probe, a SNAIL (Splint Nucleotide Assisted Intramolecular Ligation) probe set, a PLAYR (Proximity Ligation Assay for RNA) probe set, a PLISH (Proximity Ligation in situ Hybridization) probe set, and RNA-templated ligation probes. The specific probe or probe set design can vary.

### Ligation

In some embodiments, a product of an endogenous analyte and/or a labelling agent is a ligation product. In some embodiments, the ligation product is formed between two or more endogenous analytes. In some embodiments, the ligation product is formed between an endogenous analyte and a labelling agent. In some embodiments, the ligation product is formed between two or more labelling agent. In some embodiments, the ligation product is an intramolecular ligation of an endogenous analyte. In some embodiments, the ligation product is an intramolecular ligation of a labelling agent, for example, the circularization of a circularizable probe or probe set upon hybridization to a target sequence. The target sequence can be included in an endogenous analyte (e.g., nucleic acid such as a genomic DNA or mRNA) or a product thereof (e.g., cDNA from a cellular mRNA transcript), or in a labelling agent (e.g., the reporter oligonucleotide) or a product thereof.

In some embodiments, the ligation involves chemical ligation. In some embodiments, the ligation involves template dependent ligation. In some embodiments, the ligation involves template independent ligation. In some embodiments, the ligation involves enzymatic ligation.

In some embodiments, the enzymatic ligation involves use of a ligase. In some aspects, the ligase used herein includes an enzyme that is commonly used to join polynucleotides together or to join the ends of a single polynucleotide. An RNA ligase, a DNA ligase, or another variety of ligase can be used to ligate two nucleotide sequences together. Ligases include ATP-dependent double-strand polynucleotide ligases, NAD-i-dependent double-strand DNA or RNA ligases and single-strand polynucleotide ligases, for example any of the ligases described in EC 6.5.1.1 (ATP-dependent ligases), EC 6.5.1.2 (NAD+-dependent ligases), EC 6.5.1.3 (RNA ligases). Specific examples of ligases include bacterial ligases such as E. coli DNA ligase, Tth DNA ligase, Thermococcus sp. (strain 9° N) DNA ligase (9° N™ DNA ligase, New England Biolabs), Taq DNA ligase, Ampligase™ (Epicentre Biotechnologies) and phage ligases such as T3 DNA ligase, T4 DNA ligase and T7 DNA ligase and mutants thereof. In some embodiments, the ligase is a T4 RNA ligase. In some embodiments, the ligase is a splintR ligase. In some embodiments, the ligase is a single stranded DNA ligase. In some embodiments, the ligase is a T4 DNA ligase. In some embodiments, the ligase is a ligase that has an DNA-splinted DNA ligase activity. In some embodiments, the ligase is a ligase that has an RNA-splinted DNA ligase activity.

In some embodiments, the ligation herein is a direct ligation. In some embodiments, the ligation herein is an indirect ligation. “Direct ligation” means that the ends of the polynucleotides hybridize immediately adjacently to one another to form a substrate for a ligase enzyme resulting in their ligation to each other (intramolecular ligation). Alternatively, “indirect” means that the ends of the polynucleotides hybridize non-adjacently to one another, i.e., separated by one or more intervening nucleotides or “gaps”. In some embodiments, said ends are not ligated directly to each other, but instead occurs either via the intermediacy of one or more intervening (so-called “gap” or “gap-filling” (oligo)nucleotides) or by the extension of the 3′ end of a probe to “fill” the “gap” corresponding to said intervening nucleotides (intermolecular ligation). In some cases, the gap of one or more nucleotides between the hybridized ends of the polynucleotides may be “filled” by one or more “gap” (oligo)nucleotide(s) which are complementary to a splint, padlock probe, or target nucleic acid. The gap may be a gap of 1 to 60 nucleotides or a gap of 1 to 40 nucleotides or a gap of 3 to 40 nucleotides. In specific embodiments, the gap may be a gap of about 1, 2, 3, 4, 5, 6, 7, 8, 9, or 10 or more nucleotides, of any integer (or range of integers) of nucleotides in between the indicated values. In some embodiments, the gap between said terminal regions may be filled by a gap oligonucleotide or by extending the 3′ end of a polynucleotide. In some cases, ligation involves ligating the ends of the probe to at least one gap (oligo)nucleotide, such that the gap (oligo)nucleotide becomes incorporated into the resulting polynucleotide. In some embodiments, the ligation herein is preceded by gap filling. In other embodiments, the ligation herein does not require gap filling.

In some embodiments, ligation of the polynucleotides produces polynucleotides with melting temperature higher than that of unligated polynucleotides. Thus, in some aspects, ligation stabilizes the hybridization complex containing the ligated polynucleotides prior to subsequent steps, including amplification and detection.

In some aspects, a high fidelity ligase, such as a thermostable DNA ligase (e.g., a Taq DNA ligase), is used. Thermostable DNA ligases are active at elevated temperatures, allowing further discrimination by incubating the ligation at a temperature near the melting temperature (Tm) of the DNA strands. This selectively reduces the concentration of annealed mismatched substrates (expected to have a slightly lower Tm around the mismatch) over annealed fully base-paired substrates. Thus, high-fidelity ligation can be achieved through a combination of the intrinsic selectivity of the ligase active site and balanced conditions to reduce the incidence of annealed mismatched dsDNA.

In some embodiments, the ligation herein is a proximity ligation of ligating two (or more) nucleic acid sequences that are in proximity with each other, e.g., through enzymatic means (e.g., a ligase). In some embodiments, proximity ligation can include a “gap-filling” step that involves incorporation of one or more nucleic acids by a polymerase, based on the nucleic acid sequence of a template nucleic acid molecule, spanning a distance between the two nucleic acid molecules of interest (see, e.g., U.S. Pat. No. 7,264,929, the entire contents of which are incorporated herein by reference). A wide variety of different methods can be used for proximity ligating nucleic acid molecules, including (but not limited to) “sticky-end” and “blunt-end” ligations. Additionally, single-stranded ligation can be used to perform proximity ligation on a single-stranded nucleic acid molecule. Sticky-end proximity ligations involve the hybridization of complementary single-stranded sequences between the two nucleic acid molecules to be joined, prior to the ligation event itself. Blunt-end proximity ligations generally do not include hybridization of complementary regions from each nucleic acid molecule because both nucleic acid molecules lack a single-stranded overhang at the site of ligation.

### Primer Extension and Amplification

In some embodiments, a product is a primer extension product of an analyte, a labelling agent, a probe or probe set bound to the analyte (e.g., a circularizable probe bound to genomic DNA, mRNA, or cDNA), or a probe or probe set bound to the labelling agent (e.g., a circularizable probe bound to one or more reporter oligonucleotides from the same or different labelling agents).

A primer is generally a single-stranded nucleic acid sequence having a 3′ end that can be used as a substrate for a nucleic acid polymerase in a nucleic acid extension reaction. RNA primers are formed of RNA nucleotides, and are used in RNA synthesis, while DNA primers are formed of DNA nucleotides and used in DNA synthesis. Primers can also include both RNA nucleotides and DNA nucleotides (e.g., in a random or designed pattern). Primers can also include other natural or synthetic nucleotides described herein that can have additional functionality. In some examples, DNA primers can be used to prime RNA synthesis and vice versa (e.g., RNA primers can be used to prime DNA synthesis). Primers can vary in length. For example, primers can be about 6 bases to about 120 bases. For example, primers can include up to about 25 bases. A primer, may in some cases, refer to a primer binding sequence. A primer extension reaction generally refers to any method where two nucleic acid sequences become linked (e.g., hybridized) by an overlap of their respective terminal complementary nucleic acid sequences (i.e., for example, 3′ termini). Such linking can be followed by nucleic acid extension (e.g., an enzymatic extension) of one, or both termini using the other nucleic acid sequence as a template for extension. Enzymatic extension can be performed by an enzyme including, but not limited to, a polymerase and/or a reverse transcriptase.

In some embodiments, a product of an endogenous analyte and/or a labelling agent is an amplification product of one or more polynucleotides, for instance, a circular probe or circularizable probe or probe set. In some embodiments, the amplifying is achieved by performing rolling circle amplification (RCA). In other embodiments, a primer that hybridizes to the circular probe or circularized probe is added and used as such for amplification. In some embodiments, the RCA includes a linear RCA, a branched RCA, a dendritic RCA, or any combination thereof.

In some embodiments, the amplification is performed at a temperature between or between about 20° C. and about 60° C. In some embodiments, the amplification is performed at a temperature between or between about 30° C. and about 40° C. In some aspects, the amplification step, such as the rolling circle amplification (RCA) is performed at a temperature between at or about 25° C. and at or about 50° C., such as at or about 25° C., 27° C., 29° C., 31° C., 33° C., 35° C., 37° C., 39° C., 41° C., 43° C., 45° C., 47° C., or 49° C.

In some embodiments, upon addition of a DNA polymerase in the presence of appropriate dNTP precursors and other cofactors, a primer is elongated to produce multiple copies of the circular template. This amplification step can utilize isothermal amplification or non-isothermal amplification.

### Target Sequences

A target sequence for a probe disclosed herein may be included in any analyte disclose herein, including an endogenous analyte (e.g., a viral or cellular nucleic acid), a labelling agent, or a product of an endogenous analyte and/or a labelling agent.

In some aspects, one or more of the target sequences includes one or more barcode(s), e.g., at least two, three, four, five, six, seven, eight, nine, ten, or more barcodes. Barcodes can spatially-resolve molecular components found in biological samples, for example, within a cell or a tissue sample. A barcode can be attached to an analyte or to another moiety or structure in a reversible or irreversible manner. A barcode can be added to, for example, a fragment of a deoxyribonucleic acid (DNA) or ribonucleic acid (RNA) sample before or during sequencing of the sample. Barcodes can allow for identification and/or quantification of individual sequencing-reads (e.g., a barcode can be or can include a unique molecular identifier or “UMI”). In some aspects, a barcode includes about 4, 5, 6, 7, 8, 9, 10, 11, 12, 13, 14, 15, 16, 17, 18, 19, 20, 21, 22, 23, 24, 25, 26, 27, 28, 29, 30, or more than 30 nucleotides.

In some embodiments, a barcode includes two or more sub-barcodes that together function as a single barcode. For example, a polynucleotide barcode can include two or more polynucleotide sequences (e.g., sub-barcodes) that are separated by one or more non-barcode sequences. In some embodiments, the one or more barcode(s) can also provide a platform for targeting functionalities, such as oligonucleotides, oligonucleotide-antibody conjugates, oligonucleotide-streptavidin conjugates, modified oligonucleotides, affinity purification, detectable moieties, enzymes, enzymes for detection assays or other functionalities, and/or for detection and identification of the polynucleotide.

In some embodiments, in a barcode sequencing method, barcode sequences are detected for identification of other molecules including nucleic acid molecules (DNA or RNA) longer than the barcode sequences themselves, as opposed to direct sequencing of the longer nucleic acid molecules. In some embodiments, a N-mer barcode sequence includes 4N complexity given a sequencing read of N bases, and a much shorter sequencing read may be required for molecular identification compared to non-barcode sequencing methods such as direct sequencing. For example, 1024 molecular species may be identified using a 5-nucleotide barcode sequence (45=1024), whereas 8 nucleotide barcodes can be used to identify up to 65,536 molecular species, a number greater than the total number of distinct genes in the human genome. In some embodiments, the barcode sequences contained in the probes or RCPs are detected, rather than endogenous sequences, which can be an efficient read-out in terms of information per cycle of sequencing. Because the barcode sequences are pre-determined, they can also be designed to feature error detection and correction mechanisms, see, e.g., U.S. Pat. Pub. 20190055594 and WO2019199579A1, which are hereby incorporated by reference in their entirety.

### Assays

The methods described herein may be useful for analysis methods in which specific reagents are added to a sample. In some embodiments, reagents are added to the sample in the device which include but are not limited to oligonucleotides (e.g., probes, dNTPs, primers), enzymes (e.g., endonucleases to fragment DNA, DNA polymerase enzymes, RNA polymerase, transposase, ligase, proteinase K, reverse transcriptase enzymes, including enzymes with terminal transferase activity, and DNAse), buffers and washes. In some embodiments, optical labels or dyes are added to the sample. In some embodiments, a sample can be collected from the device after performing steps of the assay described herein. In some embodiments, the device is used to perform or prepare sample for in situ analysis methods which include, e.g., in situ hybridization and in situ sequencing. In situ hybridization is a hybridization process in which labeled nucleic acids that are complementary to a specific nucleic acid (e.g., DNA or RNA) sequence in a biological sample hybridize to a portion or section of the sample (e.g., tissue) in which the nucleic acid is present. The methods described herein may be useful for array-based methods in which specific reagents are contacted with a sample. In some embodiments, the surface of the fluidic interface layer or substrate layer may have an array of bound reagents. In some embodiments, a device is used to deliver reagents to the sample which is deposited on the array.

The labeled nucleic acids, also referred to as probes, are generally short oligonucleotides in which at least a portion of the oligonucleotide is a reverse complement to a target nucleic acid of interest. The probes may include additional components in addition to the hybridization portion. For example, the probes may include additional sequences (e.g., barcode sequences), that are unique labels or identifiers to convey information about the nucleic acid being detected. The probes may further include a label attached thereto, directly or indirectly. The label may be, e.g., an optical label, a molecular label (e.g., an antigen), a radiolabel, or a field attractable label (e.g., electric or magnetic). In some embodiments the optical label is a fluorescent label, e.g., as used in fluorescence in situ hybridization (FISH). A fluorescent label can be detected by routine optical detection methods known in the art.

Optical detection may be performed by any detector capable of measuring light (e.g., the emitted, scattered, or attenuated light) from the label. Suitable detectors include, but are not limited to, a spectrometer, a light meter, a photometer, a photodiode, a photomultiplier tube, a CCD array, a CMOS sensor, or a photovoltaic device.

In situ methods may first include fixing and/or permeabilizing a biological sample (e.g., tissue). The biological sample may be provided in the device, e.g., on a substrate layer. The sample may be permeabilized by adding a fluid, such as a solvent (e.g., acetone and methanol) or a detergent (e.g., TRITON X-100, NP-40, TWEEN 20, saponin, digitonin, and Leucoperm), to the sample. Permeabilization may allow or enhance access of the probes for the intracellular space of the sample.

In some embodiments, a plurality of probes is used, e.g., for ease of detection and/or signal amplification, such as any probes described herein. For example, a first probe may include a nucleic acid sequence that hybridizes to a target nucleic acid in the sample. A secondary probe that includes a label (e.g., optical label, e.g., fluorescent label) may then be added that hybridizes to the first probe. In some embodiments, a plurality of secondary or higher order (e.g., tertiary, quaternary) detection probes are added. Each probe may be provided by a separate fluid source. Each probe may be provided by a single fluid source that includes a plurality of distinct probes.

When a probe that includes a detection label is added, the unbound probes with detection labels can be washed away and the signal can be detected, e.g., via fluorescence microscopy.

In some embodiments, the signal or template target nucleic acid is amplified. In some embodiments, an analyte (e.g., target nucleic acid) can be amplified using an enzyme, e.g., by polymerase chain reaction (PCR) or rolling circle amplification (RCA). The target nucleic acid may be replicated, e.g., by using the probe as a primer to initiate DNA or RNA synthesis. In such an embodiment, one or more fluids are added (e.g., sequentially) to the sample to provide the reagents for nucleic acid synthesis. Suitable reagents include, but are not limited to, probes, primers, nucleotide triphosphates (NTPs, e.g., dNTPs), sequencing terminators, dyes, polymerases, ligases, transcriptases (e.g., reverse transcriptases), labels, and the like.

In some embodiments, the methods described herein includes in situ sequencing or sequence detection. One such process includes temporal multiplexing of barcoded probes. In some embodiments, a primary probe or set of primary probes (e.g., 24 primary probes) hybridize to a target nucleic acid (e.g., mRNA) in the sample. Each probe may contain a barcode attached thereto. The barcodes may then be detected by contacting with one or more probes each labeled with a fluorescent label which emits a signal. Each round of barcoding may be initiated by flowing the desired probe from a new fluid source. The labels may be detected using different excitation wavelengths (e.g., 640 nm, 561 nm, or 488 nm) during different barcoding rounds. By compiling the spatiotemporal patterns of each fluorescent signal at a location, the unique set of ordered barcode sequences that corresponds to a particular gene can be determined. Such a method may allow multiplex sequencing of a large number of (e.g., of 100, 1,000, 10,000, or more) nucleic acids, e.g., up to 90,000 transcripts per cell. This method also allows for efficient quantification of low-copy number nucleic acids.

In some embodiments, the in situ detection and/or in situ sequencing is performed in three dimensions. In this embodiment, the biological sample may be sequence by using a probe that includes a unique gene identifier. The probe may be ligated, thereby allowing extension and amplification of the target sequence. In some embodiments, the amplification product can then be modified with a chemical moiety that polymerizes in the presence of a polymerization initiator. In some embodiments, an amplified product may be embedded within a polymerized matrix (e.g., a hydrogel), thereby creating spatially fixed three-dimensional target analytes of the biological sample.

In some embodiments, the in situ sequencing includes sequencing by ligation. In this embodiment, fluorescently labeled probes with two known bases followed by degenerate or universal bases hybridize to a temple. A ligase immobilizes the complex and the biological sample is imaged to detect the label on the probe. Following detection, the fluorophore is cleaved from the probe along with several bases, revealing a free 5′ phosphate. This process of hybridization, ligation, imaging, and cleavage can be repeating in multiple rounds, thereby allowing identification of, e.g., 2 out of every 5 bases. After a round of probe extension, all probes and anchors are removed and the cycle can begin again with an offset anchor, thus allowing sequencing of a new register of the target.

In another embodiment, sequencing by ligation includes labeled probes with a known base (e.g., A, C, T, or G) flanked on each side of the known base by degenerate or universal bases that hybridize to a template (e.g., three or four bases on each side). Each probe contains a different fluorescent label corresponding to each individual base. Each round of sequencing includes hybridizing a probe with a known base, ligation of the probe, detection, and optionally, cleavage of the fluorescent label. Sequencing can be performed in a plus or minus direction, and rounds of sequencing can begin again with an offset anchor, thus allowing sequencing of a new register of the target.

In some embodiments, detection of one or more analytes (e.g., protein analytes) can be performed using one or more analyte capture agents. In some embodiment, the devices described herein may include one or more analyte capture agents, e.g., an array of oligonucleotides. In some aspects, the array may include a bead array. As used herein, an “analyte capture agent” refers to an agent that interacts with an analyte (e.g., an analyte in a biological sample) and with a capture probe (e.g., a capture probe attached to a substrate or a feature) to identify the analyte. In some embodiments, the analyte capture agent includes: (i) an analyte binding moiety (e.g., that binds to an analyte), for example, an antibody or antigen-binding fragment thereof; (ii) analyte binding moiety barcode; and (iii) an analyte capture sequence. As used herein, the term “analyte binding moiety barcode” refers to a barcode that is associated with or otherwise identifies the analyte binding moiety. As used herein, the term “analyte capture sequence” refers to a region or moiety configured to hybridize to, bind to, couple to, or otherwise interact with a capture domain of a capture probe. In some cases, an analyte binding moiety barcode (or portion thereof) may be able to be removed (e.g., cleaved) from the analyte capture agent. Additional description of analyte capture agents can be found in Section (II)(b)(ix) of WO 2020/176788 and/or Section (II)(b)(viii) U.S. Patent Application Publication No. 2020/0277663.

There are at least two methods to associate a spatial barcode with one or more neighboring cells, such that the spatial barcode identifies the one or more cells, and/or contents of the one or more cells, as associated with a particular spatial location. One method is to promote analytes or analyte proxies (e.g., intermediate agents) out of a cell and towards a spatially-barcoded array (e.g., including spatially-barcoded capture probes). Another method is to cleave spatially-barcoded capture probes from an array and promote the spatially-barcoded capture probes towards and/or into or onto the biological sample.

In some cases, capture probes may be configured to prime, replicate, and consequently yield optionally barcoded extension products from a template (e.g., a DNA or RNA template, such as an analyte or an intermediate agent (e.g., a ligation product or an analyte capture agent), or a portion thereof), or derivatives thereof (see, e.g., Section (II)(b)(vii) of WO 2020/176788 and/or U.S. Patent Application Publication No. 2020/0277663 regarding extended capture probes). In some cases, capture probes may be configured to form ligation products with a template (e.g., a DNA or RNA template, such as an analyte or an intermediate agent, or portion thereof), thereby creating ligations products that serve as proxies for a template.

As used herein, an “extended capture probe” refers to a capture probe having additional nucleotides added to the terminus (e.g., 3′ or 5′ end) of the capture probe thereby extending the overall length of the capture probe. For example, an “extended 3′ end” indicates additional nucleotides were added to the most 3′ nucleotide of the capture probe to extend the length of the capture probe, for example, by polymerization reactions used to extend nucleic acid molecules including templated polymerization catalyzed by a polymerase (e.g., a DNA polymerase or a reverse transcriptase). In some embodiments, extending the capture probe includes adding to a 3′ end of a capture probe a nucleic acid sequence that is complementary to a nucleic acid sequence of an analyte or intermediate agent specifically bound to the capture domain of the capture probe. In some embodiments, the capture probe is extended using reverse transcription. In some embodiments, the capture probe is extended using one or more DNA polymerases. The extended capture probes include the sequence of the capture probe and the sequence of the spatial barcode of the capture probe.

In some embodiments, extended capture probes are amplified (e.g., in bulk solution or on the array) to yield quantities that are sufficient for downstream analysis, e.g., via DNA sequencing. In some embodiments, extended capture probes (e.g., DNA molecules) act as templates for an amplification reaction (e.g., a polymerase chain reaction).

Additional variants of spatial analysis methods, including in some embodiments, an imaging step, are described in Section (II)(a) of WO 2020/176788 and/or U.S. Patent Application Publication No. 2020/0277663. Analysis of captured analytes (and/or intermediate agents or portions thereof), for example, including sample removal, extension of capture probes, sequencing (e.g., of a cleaved extended capture probe and/or a cDNA molecule complementary to an extended capture probe), sequencing on the array (e.g., using, for example, in situ hybridization or in situ ligation approaches), temporal analysis, and/or proximity capture, is described in Section (II)(g) of WO 2020/176788 and/or U.S. Patent Application Publication No. 2020/0277663. Some quality control measures are described in Section (II)(h) of WO 2020/176788 and/or U.S. Patent Application Publication No. 2020/0277663.

Spatial information can provide information of biological and/or medical importance. For example, the methods and compositions described herein can allow for: identification of one or more biomarkers (e.g., diagnostic, prognostic, and/or for determination of efficacy of a treatment) of a disease or disorder; identification of a candidate drug target for treatment of a disease or disorder; identification (e.g., diagnosis) of a subject as having a disease or disorder; identification of stage and/or prognosis of a disease or disorder in a subject; identification of a subject as having an increased likelihood of developing a disease or disorder; monitoring of progression of a disease or disorder in a subject; determination of efficacy of a treatment of a disease or disorder in a subject; identification of a patient subpopulation for which a treatment is effective for a disease or disorder; modification of a treatment of a subject with a disease or disorder; selection of a subject for participation in a clinical trial; and/or selection of a treatment for a subject with a disease or disorder.

Spatial information can provide information of biological importance. For example, the methods and compositions described herein can allow for: identification of transcriptome and/or proteome expression profiles (e.g., in healthy and/or diseased tissue); identification of multiple analyte types in close proximity (e.g., nearest neighbor analysis); determination of up- and/or down-regulated genes and/or proteins in diseased tissue; characterization of tumor microenvironments; characterization of tumor immune responses; characterization of cells types and their co-localization in tissue; and identification of genetic variants within tissues (e.g., based on gene and/or protein expression profiles associated with specific disease or disorder biomarkers).

Typically, for spatial array-based methods, a substrate layer (e.g., as described herein) functions as a support for direct or indirect attachment of capture probes to features of the array. A “feature” is an entity that acts as a support or repository for various molecular entities used in spatial analysis. In some embodiments, some or all of the features in an array are functionalized for analyte capture. Exemplary substrates are described in Section (II)(c) of WO 2020/176788 and/or U.S. Patent Application Publication No. 2020/0277663. Exemplary features and geometric attributes of an array can be found in Sections (II)(d)(i), (II)(d)(iii), and (II)(d)(iv) of WO 2020/176788 and/or U.S. Patent Application Publication No. 2020/0277663.

Generally, analytes and/or intermediate agents (or portions thereof) can be captured when contacting a biological sample with a substrate including capture probes (e.g., a substrate with capture probes embedded, spotted, printed, fabricated on the substrate, or a substrate with features (e.g., beads, wells) including capture probes). As used herein, “contact,” “contacted,” and/or “contacting,” a biological sample with a substrate refers to any contact (e.g., direct or indirect) such that capture probes can interact (e.g., bind covalently or non-covalently (e.g., hybridize)) with analytes from the biological sample. Capture can be achieved actively (e.g., using electrophoresis) or passively (e.g., using diffusion). Analyte capture is further described in Section (II)(e) of WO 2020/176788 and/or U.S. Patent Application Publication No. 2020/0277663.

In some cases, spatial analysis can be performed by attaching and/or introducing a molecule (e.g., a peptide, a lipid, or a nucleic acid molecule) having a barcode (e.g., a spatial barcode) to a biological sample (e.g., to a cell in a biological sample). In some embodiments, a plurality of molecules (e.g., a plurality of nucleic acid molecules) having a plurality of barcodes (e.g., a plurality of spatial barcodes) are introduced to a biological sample (e.g., to a plurality of cells in a biological sample) for use in spatial analysis. In some embodiments, after attaching and/or introducing a molecule having a barcode to a biological sample, the biological sample can be physically separated (e.g., dissociated) into single cells or cell groups for analysis. Some such methods of spatial analysis are described in Section (III) of WO 2020/176788 and/or U.S. Patent Application Publication No. 2020/0277663.

In some embodiments, the macromolecular components (e.g., analytes) of individual biological samples (e.g., cells) can be identified or detected with unique identifiers (e.g., barcodes) such that upon characterization of those macromolecular components, such that any given component (e.g., bioanalyte) may be traced to the biological sample (e.g., cell) from which it was obtained. The ability to attribute characteristics to individual biological samples or groups of biological samples is provided by the assignment of unique identifiers specifically to an individual biological sample or groups of biological samples. Unique identifiers, for example, in the form of nucleic acid barcodes, can be assigned or associated with individual biological samples (e.g., cells) or populations of biological samples (e.g., cells), or genes (e.g., mRNA transcripts, in order to tag or label the biological sample's macromolecular components (and as a result, its characteristics) with the unique identifiers. These unique identifiers can then be used to attribute the biological sample's components and characteristics to an individual biological sample or group of biological samples.

In some aspects, the unique identifiers are provided in the form of oligonucleotides that include nucleic acid barcode sequences that may be attached to or otherwise associated with the nucleic acid contents of individual biological sample, or to other components of the biological sample, and particularly to fragments of those nucleic acids.

The nucleic acid barcode sequences can include from 6 to about 20 or more nucleotides within the sequence of the oligonucleotides. In some cases, the length of a barcode sequence may be 6, 7, 8, 9, 10, 11, 12, 13, 14, 15, 16, 17, 18, 19, 20 nucleotides or longer. In some cases, the length of a barcode sequence may be at least 6, 7, 8, 9, 10, 11, 12, 13, 14, 15, 16, 17, 18, 19, 20 nucleotides or longer. In some cases, the length of a barcode sequence may be at most 6, 7, 8, 9, 10, 11, 12, 13, 14, 15, 16, 17, 18, 19, 20 nucleotides or shorter. These nucleotides may be completely contiguous, i.e., in a single stretch of adjacent nucleotides, or they may be separated into two or more separate subsequences that are separated by 1 or more nucleotides. In some cases, separated barcode subsequences can be from about 4 to about 16 nucleotides in length. In some cases, the barcode subsequence may be 4, 5, 6, 7, 8, 9, 10, 11, 12, 13, 14, 15, 16 nucleotides or longer. In some cases, the barcode subsequence may be at least 4, 5, 6, 7, 8, 9, 10, 11, 12, 13, 14, 15, 16 nucleotides or longer. In some cases, the barcode subsequence may be at most 4, 5, 6, 7, 8, 9, 10, 11, 12, 13, 14, 15, 16 nucleotides or shorter.

Moieties (e.g., oligonucleotides) used in the methods described herein can also include other functional sequences useful in processing of nucleic acids from biological samples contained in the droplet. These sequences include, for example, targeted or random/universal amplification primer sequences for amplifying the genomic DNA from the individual biological samples within the droplets while attaching the associated barcode sequences, sequencing primers or primer recognition sites, hybridization or probing sequences, e.g., for identification of presence of the sequences or for pulling down barcoded nucleic acids, or any of a number of other potential functional sequences.

The methods described herein may include providing molecular labels, e.g., via a fluid source. The molecular labels may include barcodes (e.g., nucleic acid barcodes). The molecular labels can be provided to the biological sample based on a number of different methods including, without limitation, microinjection, electroporation, liposome-based methods, nanoparticle-based methods, and lipophilic moiety-barcode conjugate methods. For instance, a lipophilic moiety conjugated to a nucleic acid barcode may be contacted with cells or particulate components of interest. The lipophilic moiety may insert into the plasma membrane of a cell thereby labeling the cell with the barcode. The devices and methods of the present disclosure may result in molecular labels being present on (i) the interior of a cell or particulate component and/or (ii) the exterior of a cell or particulate component (e.g., on or within the cell membrane). These and other suitable methods will be appreciated by those skilled in the art (see U.S. Pub. Nos. US20190177800, US20190323088, US20190338353, and US20200002763, each of which is incorporated herein by reference in its entirety).

In an example, a fluid is provided that includes large numbers of the above-described barcoded oligonucleotides releasably attached to a label. In some cases, a fluid will provide a diverse barcode sequence library that includes at least about 1,000 different barcode sequences, at least about 5,000 different barcode sequences, at least about 10,000 different barcode sequences, at least about 50,000 different barcode sequences, at least about 100,000 different barcode sequences, at least about 1,000,000 different barcode sequences, at least about 5,000,000 different barcode sequences, or at least about 10,000,000 different barcode sequences, or more.

Oligonucleotides may be releasable from the labels (e.g., optical label, e.g., fluorescent label) upon the application of a particular stimulus. In some cases, the stimulus may be a photo-stimulus, e.g., through cleavage of a photo-labile linkage that releases the oligonucleotides. In other cases, a thermal stimulus may be used, where increase in temperature will result in cleavage of a linkage or other release of the oligonucleotides from the label. In still other cases, a chemical stimulus is used that cleaves a linkage of the oligonucleotides to the label, or otherwise results in release of the oligonucleotides from the label, e.g., beads.

### Methods of Device Manufacture

The devices of the present disclosure may be fabricated in any of a variety of conventional ways. These structures may be fabricated in whole or in part from polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof.

A gasket of the present disclosure may be made in whole or in part from, e.g., a polymer, e.g., a silicone (e.g., silicone rubbers, e.g., PDMS), fluorosilicone, FKM, FFKM, COC elastomer, etc. The gasket may include an elastomeric polymer, e.g., be cut or formed from an elastomeric material, or precursors thereof, e.g., to allow the gasket to be compressible. A gasket may be a composite of compressible and incompressible materials, e.g., an elastomeric polymer bonded to a non-elastomeric polymer, e.g., formed by bonding (e.g., thermally or with adhesive) two or more materials together. Gaskets may include thermoset or thermoplastic polymers, or a combination thereof. A gasket may be coated, e.g., to include a one-sided adhesive, a double-sided adhesive, a polymer coating, or a hydrophobic coating. A hydrophobic coating on the gasket may act to improve sealing (e.g., to prevent leaks), and/or to reduce adhesion between the gasket and the fluidic interface layer and/or substrate layer, e.g., to allow for easier removal.

A gasket of the disclosure may be formed in place on the fluidic interface layer. For example, a gasket may be printed in place, e.g., using screen printing, CNC controlled nozzle deposition, 3D printing of elastomers on the surface, UV curable processes (e.g., stereolithography), etc. In some embodiments, a gasket may be formed on the fluidic interface by dispensing beads of curable elastomers, e.g., moisture or UV curable elastomers, or, e.g., two-part RTV elastomers. In some embodiments, a gasket may be produced by laser cutting of a continuous gasket layer already laminated on to the substrate layer or fluidic interface layer.

The fluidic interface layer and substrate layers may be made in whole or in part from glass, polymer (e.g., polystyrene, polycarbonate, polyethylene terephthalate, polypropylene, polyethylene, PTFE, COC, PMMA, etc.), plastic, ceramic, metal, or a combination thereof. The fluidic interface may be constructed of multiple layers, e.g., a top layer and a bottom layer.

Polymeric device components may be fabricated using any of a number of processes including soft lithography, embossing techniques, micromachining, e.g., laser machining, or, in some aspects, injection molding of the layer components that include the defined channels as well as other structures, e.g., reservoirs, integrated functional components, etc. In such cases, a laminating layer may be adhered to the molded structured part through readily available methods, including thermal lamination, solvent based lamination, sonic welding, or the like.

As will be appreciated, structures included of inorganic materials also may be fabricated using known techniques. For example, structures such as channels or reservoirs may be micro-machined into surfaces or etched into the surfaces using standard photolithographic techniques. In some aspects, the devices or components thereof may be fabricated using three- dimensional printing techniques to fabricate the channel or other structures of the devices and/or their discrete components.

### Methods for Surface Modifications

The disclosure features methods for producing a flow device (e.g., a microfluidic device) that has a surface modification, e.g., a surface with a modified water contact angle. The methods may be employed to modify the surface of a device such that a liquid can “wet” the surface by altering the contact angle the liquid makes with the surface.

Devices to be modified with surface coating agents may be primed, e.g., pre-treated, before coating processes occur. In certain embodiments, the first contact angle is greater than the water contact angle of the primed surface. In other embodiments, the first contact angle is greater than the water contact angle of the device component surface. Thus, the method allows for the differential coating of surfaces within or on the device.

A surface may be primed by depositing a metal oxide onto it. Example metal oxides useful for priming surfaces include, but are not limited to, Al2O3, TiO2, SiO2, or a combination thereof. Other metal oxides useful for surface modifications are known in the art. The metal oxide can be applied to the surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al2O3 can be prepared on a surface by depositing trimethylaluminum (TMA) and water.

In some cases, the coating agent may create a surface that has a water contact angle greater than 90°, e.g., hydrophobic or fluorophillic, or may create a surface with a water contact angle of less than 90°, e.g., hydrophilic. For example, a fluorophillic surface may be created by flowing fluorosilane (e.g., H3FSi) through a primed device surface, e.g., a surface coated in a metal oxide. The priming of the surfaces of the device enhances the adhesion of the coating agents to the surface by providing appropriate surface functional groups. In some cases, the coating agent used to coat the primed surface may be a liquid reagent.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. An assembly comprising:
a substrate configured to receive a sample;
a gasket having an upper surface and a lower surface defining a first thickness therebetween, a void having a first cutout at a first end of the void and a second cutout at a second end of the void opposite the first end, a plurality of cover supports extending into the void, wherein the plurality of cover supports has a second thickness that is less than the first thickness; and
a cover configured to be positioned within the void and supported by the plurality of cover supports, wherein, when the cover is positioned within the void, a gasket inlet is formed by the first cutout and the cover and a gasket outlet is formed by the second cutout and the cover to thereby define a closed flow cell between the substrate, gasket and cover.

2. The assembly of claim 1, further comprising:
a base having an upper surface and a lower surface defining a thickness therebetween, where the substrate is disposed on the upper surface of the base;
a top having:
an upper surface and a lower surface defining a thickness therebetween,
the top configured to removably couple to the base; and
at least one opening extending through the upper surface and lower surface with at least one downwardly extending wall disposed around a perimeter of the opening, wherein the cover extends across the opening in the top.

3. The assembly of claim 2, further comprising a fluidic inlet and a fluidic outlet at opposite sides of the opening.

4. The assembly of claim 3, wherein the fluidic inlet of the top and the fluidic outlet of the top are oriented vertically with respect to the upper surface of the top.

5. The assembly of claim 3, wherein the fluidic inlet of the top and the fluidic outlet of the top extend vertically above the upper surface of the top.

6. The assembly of claim 2, wherein the gasket inlet is vertically aligned with the fluidic inlet of the top, and the gasket outlet is vertically aligned with the fluidic outlet of the top.

7. The assembly of claim 2, wherein at least one of the fluidic inlet or the fluidic outlet has an orifice of greater diameter than an orifice of the gasket inlet or the gasket outlet.

8. The assembly of claim 2, wherein the top includes a plurality of snap joints at opposite sides thereof, the snap joints configured to removably couple the top to corresponding lugs of the base with the substrate, gasket and cover fixedly disposed therebetween.

9. The assembly of claim 2, wherein the closed flow cell directs fluids received from the fluidic inlet to the fluidic outlet of the top.

10. A method of assembling a reversible flow cell, the method comprising:
providing a substrate configured to receive a sample;
positioning a gasket on the substrate, the gasket having an upper surface and a lower surface defining a first thickness therebetween, a void, a plurality of cover supports extending into the void, a first cutout positioned at a first end of the void, and a second cutout positioned at a second end of the void opposite the first end, wherein the plurality of cover supports has a second thickness that is less than the first thickness; and
positioning a cover within the void such that the cover is supported by the plurality of cover supports, wherein, when the cover is positioned within the void, a gasket inlet is defined by the first cutout and the cover and a gasket outlet is defined by the second cutout and the cover to thereby define a closed flow cell between the substrate, gasket and cover.

11. An assembly comprising:
a base including:
an upper surface and a lower surface defining a thickness therebetween,
at least one vacuum port formed in the upper surface;
at least one substrate disposed on the upper surface of the base, the substrate configured to receive a sample;
a gasket disposed over the substrate, the gasket including a plurality of apertures with at least one aperture disposed over the at least one vacuum port of the base, the gasket having a void with a first cutout at a first end of the void and a second cutout at a second end opposite the first end; and
a cover extending across the void and including a fluidic inlet in fluidic communication with the first cutout and a fluidic outlet in fluidic communication with the second cutout to define a closed flow cell between the substrate, gasket and the cover;
wherein a vacuum applied through the at least one vacuum port secures the cover, gasket and the at least one substrate together.

12. The assembly of claim 11, wherein the at least one vacuum port is in fluidic communication with a plurality of grooves extending between a first side and a second side of the base.

13. The assembly of claim 12, wherein a first groove of the plurality of grooves is configured as a rectangular loop, the loop vertically aligned with and disposed below the substrate.

14. The assembly of claim 13, wherein a second groove and a third groove of the plurality of grooves are configured as rectangular loops, the second loop and the third loop vertically offset with and disposed below the substrate.

15. The assembly of claim 14, wherein a plurality of apertures is vertically aligned with the second groove and the third groove of the plurality of grooves.

16. The assembly of claim 14, wherein the first groove of the plurality of grooves is disposed at a lower height in the base than the second groove and the third groove of the plurality of grooves.

17. The assembly of claim 11, wherein the flow cell is configured to transport fluids from the fluidic inlet, across the substrate, to the fluidic outlet.

18. The assembly of claim 11, wherein the base includes at least one protruding gasket registration structure configured to engage at least a portion of a gasket.

19. The assembly of claim 11, wherein the base includes at least one protruding slide registration structure configured to engage at least one side of the substrate.

20. A method of assembling a reversible flow cell, the method comprising:
providing a substrate configured to receive a sample;
positioning the substrate on a base, the base including an upper surface and a lower surface defining a thickness therebetween, and at least one vacuum port formed in the upper surface;
positioning a gasket on the substrate and the base, the gasket including a plurality of apertures with at least one aperture disposed over the least one vacuum port of the base, the gasket having a void with a first cutout at a first end of the void and a second cutout at a second end opposite the first end; and
positioning a cover over the gasket, the cover extending across the void and including a fluidic inlet in fluidic communication with the first cutout and a fluidic outlet in fluidic communication with the second cutout to define a closed flow cell between the substrate, gasket and the cover.
